(19) United States
(12) Patent Application Publication
(10) Pub. No.: US 2013/0179178 A1
(43) Pub. Date: Jul. 11, 2013

(54) SYSTEM AND METHOD FOR PATIENT CARE PLAN MANAGEMENT

(71) Applicants: Madhavi Vemireddy, New York, NY (US); Nik Nanis, Astoria, NY (US); Kimberly Paul, Jersey City, NJ (US); Kiran Ubriani, New York, NY (US); Derek Jackson, New York, NY (US); Mukesh Kitawat, Jersey City, NJ (US)

(72) Inventors: Madhavi Vemireddy, New York, NY (US); Nik Nanis, Astoria, NY (US); Kimberly Paul, Jersey City, NJ (US); Kiran Ubriani, New York, NY (US); Derek Jackson, New York, NY (US); Mukesh Kitawat, Jersey City, NJ (US)

(73) Assignee: Active Health Management, New York, NY (US)

(21) Appl. No.: 13/345,336

(22) Filed: Jan. 6, 2012

(51) Int. Cl. G06Q 50/22

(52) U.S. Cl. 705/2

(57) ABSTRACT

A method and system is described for implementing patient care management functionality. The disclosure includes querying a set of clinical rules and obtaining claims data containing clinical information relating to a plurality of patients. The system can identify patients that would benefit from care management and create a listing of markers, or conditions, associated with each identified patient based on the claims data containing clinical information relating to the patient. The system generates an individual care plan for a patient base on the identified markers and the claims data containing clinical information relating to the patient.

### FIELD OF THE INVENTION

This invention relates generally to the field of health care management and more specifically to the area of patient care plan management.

### BACKGROUND OF THE INVENTION

The health care system includes a variety of participants, including doctors, hospitals, insurance carriers, and patients. These participants frequently rely on each other for the information necessary to perform their respective roles because individual care is delivered and paid for in numerous locations by individuals and organizations that are typically unrelated. As a result, a plethora of health care information storage and retrieval systems are required to support the heavy flow of information between these participants related to patient care. Critical patient data is stored across many different locations using legacy mainframe and client-server systems that may be incompatible and/or may store information in non-standardized formats. To ensure proper patient diagnosis and treatment, health care providers must often request patient information by phone or fax from hospitals, laboratories or other providers. Therefore, disparate systems and information delivery procedures maintained by a number of independent health care system constituents lead to gaps in timely delivery of critical information and compromise the overall quality of clinical care.

Since a typical health care practice is concentrated within a given specialty, an average patient may be using services of a number of different specialists, each potentially having only a partial view of the patient's medical status. Potential gaps in complete medical records reduce the value of medical advice given to the patient by each health care provider. To obtain an overview or establish a trend of his or her medical data, a patient (and each of the patient's physicians) is forced to request the medical records separately from each individual health care provider and attempt to reconcile the piecemeal data. The complexity of medical records data also requires a significant time investment by the physician in order to read and comprehend the medical record, whether paper-based or electronic, and to ensure consistent quality of care. Additionally, while new medical research data continuously affects medical standards of care, there exists evidence of time delay and comprehension degradation in the dissemination of new medical knowledge. Existing solutions, of which there are few, have generally focused on centralized storage of health care information, but have failed to incorporate real-time analysis of a patient's health care information in order to expeditiously identify potential medical issues that may require attention. Thus, a need still exists for a computer based solution which is capable of clinically analyzing, in real-time, the accumulated health care information in light of appropriate medical standards and directly notifying the patient and the health care provider to ensure a prompt follow up on the results of the analysis. A further need exists for a computer based solution which is capable of clinically analyzing, in real-time, the accumulated health care information and generate a care plan for a patient.

### BRIEF SUMMARY OF THE INVENTION

Embodiments of the invention are used to provide an automated system for presenting a patient with an interactive personal health record powered by clinical decision support technology capable of delivering individualized alerts based on comparisons of expected medical standards of care to information related to the patient's actual medical care. Such embodiments are advantageous over previous, static health record systems that merely store and present health related information. A health care organization collects and processes a wide spectrum of medical care information in order to establish and update the relevant medical standards of care, identify the actual medical care received by the patient, and generate and deliver customized alerts, including clinical alerts and personalized wellness alerts, directly to the patient via an online interactive personal health record (PHR). The medical care information collected by the health care organization comprises patient-specific clinical data (e.g., based on claims, health care provider, and patient-entered input), as well as health reference information, including evidence-based literature relating to a plurality of medical conditions. In addition to aggregating patient-specific medical record and clinical alert information, the PHR also solicits the patient's input for tracking of alert follow-up actions. Additionally, the PHR accepts patient input of family health history, patient's allergies, current over-the-counter medications and herbal supplements, unreported and untreated conditions, as well as input for monitoring items such as blood pressure, cholesterol, and additional pertinent medical information that is likely to be within the realm of patient's knowledge.

A medical insurance carrier collects clinical information originating from medical services claims, performed procedures, pharmacy data, lab results, and provides it to the health care organization for storage in a medical database. The medical database comprises one or more medical data files located on a computer readable medium, such as a hard disk drive, a CD-ROM, a tape drive, or the like.

An on-staff team of medical professionals within the health care organization consults various sources of health reference information, including evidence-based literature, to create and continuously revise a set of clinical rules that reflect the best evidence based medical standards of care for a plurality of conditions. The clinical rules are stored in the medical database.

The PHR facilitates the patient's task of creating a complete health record by automatically populating the data fields corresponding to the information derived from the claim, pharmacy and/or lab result-based clinical data. Preferably, the PHR gathers at least some of the patient-entered data via a health risk assessment tool (HRA) that allows user entry of family history, known chronic conditions and other medical data, and provides an overall patient health assessment. Preferably, the HRA tool presents a patient with questions that are relevant to his or her medical history and currently presented conditions. The risk assessment logic branches dynamically to relevant and/or critical questions, thereby saving the patient time and providing targeted results. The data entered by the patient into the HRA also populates the corresponding data fields within other areas of PHR and generates additional clinical alerts to assist the patient in maintaining optimum health.

The health care organization aggregates the medical care information, including the patient or nurse-entered data as well as claims data, into the medical database for subsequent processing via an analytical system such as the CareEngine® System operated by Active Health Management, Inc. of New York, N.Y. The CareEngine® System is a multidimensional analytical application including a rules engine module comprising computer readable instructions that apply a set of clinical rules reflecting the best evidence-based medical standards of care for a plurality of conditions to the patient's claims and self-entered clinical data that reflects the actual care that is being delivered to the patient. The rules engine module identifies one or more instances where the patient's actual care, as evidenced by claims data (including medical procedures, tests, pharmacy data and lab results) and patient-entered clinical data, is inconsistent with the best evidence-based medical standards of care and issues patient-specific clinical alerts directly to the patient via a set of Web pages comprising the PHR tool. Additionally, the rules engine module applies specific rules to determine when the patient should be notified, via the PHR, of newly available health information relating to their clinical profile. In one embodiment, the physician gains access to the Web pages with the consent of the patient.

In an embodiment, when the rules engine module identifies an instance of actual care inconsistent with the established, best evidence-based medical standards of care, the patient is presented with a clinical alert via the PHR. In embodiments, the clinical alerts include notifications to contact the health care provider in order to start or stop a specific medication and/or to undergo a specific examination or test procedure associated with one or more conditions and co-morbidities specific to the patient. To ensure prompt patient response, the health care organization sends concurrent email notifications to the patient regarding availability of individualized alerts at the PHR. The clinical alerts notify the patient regarding known drug interactions and suggested medical therapy based on the best evidence-based medical standards of care. In addition to condition specific alerts, the rules engine module notifies the patient regarding relevant preventive health information by issuing personalized wellness alerts, via the PHR. In one embodiment, the patient is able to use the PHR to search for specific health reference information regarding a specified condition, test or medical procedure by querying the medical database via a user interface. Preferably, the PHR allows the patient to create printable reports containing the patient's health information, including health summary and health risk assessment reports, for sharing with a health care provider.

Additionally, by functioning as a central repository of a patient's medical information, the PHR empowers patients to more easily manage their own health care decisions, which is advantageous as patients increasingly move toward consumer-directed health plans.

Further embodiments include implementing a plurality of modules for providing real-time processing and delivery of clinical alerts and personalized wellness alerts to the patient via the PHR and to a health care provider via one or more health care provider applications. Specifically, the system includes a real-time application messaging module for sending and receiving real-time information via a network between the health care organization and external systems and applications. Preferably, the real-time application messaging module employs a service-oriented architecture (SOA) by defining and implementing one or more application platform-independent software services to carry real-time data between various systems and applications.

In one embodiment, the real-time application messaging module comprises web services that interface with external applications for transporting the real-time data via a Simple Object Access Protocol (SOAP) over HTTP. The message ingest web service, for example, receives real-time clinical data which is subsequently processed in real-time by the rules engine module against the best evidence-based medical standards of care. Incoming real-time data is optionally stored in the medical database.

Incoming real-time data associated with a given patient, in conjunction with previously stored data and applicable clinical rules, defines a rules engine run to be processed by the rules engine module. Hence, the real-time application messaging module collects incoming real-time clinical data from multiple sources and defines a plurality of rules engine runs associated with multiple patients for simultaneous real-time processing.

The real-time application messaging module forwards the rules engine runs to the rules engine module to instantiate a plurality of real-time rule processing sessions. The rules engine module load-balances the rule processing sessions across multiple servers to facilitate real-time matching of the clinical rules (best evidence-based medical standards of care) against multiple, simultaneous requests of incoming clinical data and patient-entered data. When the actual mode of care for a given patient deviates from the expected mode of care, the rules engine module generates one or more clinical alerts. Similarly, the rules engine module generates real-time personalized wellness alerts based on the best evidence-based medical standards of preventive health care.

During processing, the rules engine module records alert justification information in the medical database. In one embodiment, the alert justification information specifies which clinical rules have been triggered/processed by the incoming data (e.g., by rule number), which alerts have been generated (e.g., by alert number), a time/date stamp for each alert, the specific exclusionary and inclusionary information for a given patient that caused the rule to trigger (e.g., known drug allergies are used to exclude alerts recommending a drug regimen that may cause an allergic reaction), as well as patient-entered and claim information associated with the incoming real-time data that triggered a given rule.

In yet another embodiment, the rules engine module analyzes patient specific clinical data to generate a real-time risk score for various medical conditions. The risk score quantifies the severity of existing medical conditions and assesses the risk for future conditions in light of evaluating multiple risk factors in accordance with the clinical rules. For example, the risk score may identify high risk diabetics or patients subject to a risk of future stroke. The system presents the risk score to the patient, as well as to the health care provider.

Therefore, each rule processing session produces a plurality of clinical alerts, personalized wellness alerts, and/or calculates a risk score based on a set of real-time data for a given patient. The message transmit web service, in turn, delivers the generated alerts to the PHR and/or health care provider applications. Alternatively, the application messaging module comprises a single web service for both sending and receiving real-time data. To facilitate the real-time delivery of alerts, the alert payload filtering module reduces the real-time alert payload by filtering the alert input to the real-time application messaging module by a plurality of conditions and categories. In addition to improving the speed of real-time delivery of alerts, alert filtering eliminates redundant alerts and helps to focus the recipient's attention on the important alerts.

In another embodiment, patient care management functionality is implemented. The disclosure includes querying a set of clinical rules and obtaining claims data containing clinical information relating to a plurality of patients. The system can identify patients that would benefit from care management and create a listing of markers, or conditions, associated with each identified patient based on the claims data containing clinical information relating to the patient. The system generates an individual care plan for a patient base on the identified markers, goals, problems, vision goals and the claims data containing clinical information relating to the patient.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic illustrating an overview of a system for presenting a patient with a personal health record capable of delivering medical alerts, in accordance with an embodiment of the invention;

FIG. 2 is a flow chart illustrating a method for providing a customized alert to a patient, in accordance with an embodiment of the invention;

FIG. 3 is a diagram of a user interface presented by a main page of the Web-based Personal Health Record (PHR) tool of FIG. 1, in accordance with an embodiment of the invention;

FIG. 4 is a diagram of a user interface presented by an alerts detail page of the PHR tool of FIG. 1, in accordance with an embodiment of the invention;

FIG. 5 is a diagram of a user interface of a Health Risk Assessment (HRA) questionnaire of the PHR tool of FIG. 1, in accordance with an embodiment of the invention;

FIG. 6 is a diagram of a conditions and symptoms interface associated with the HRA of FIG. 5, in accordance with an embodiment of the invention;

FIG. 7 is a diagram of a family history interface associated with the HRA of FIG. 5, in accordance with an embodiment of the invention;

FIGS. 8-12 are diagrams of additional user interfaces of the PHR tool of FIG. 1 permitting patient entry of information relating to medications, allergies, immunizations, tests, and hospital visits, in accordance with an embodiment of the invention;

FIG. 13 is a diagram of a health summary interface presenting the patient with a summary of health care information available via interfaces of FIGS. 5-12, in accordance with an embodiment of the invention;

FIG. 14 is a diagram of an emergency information card generated based on at least some of the information available via the PHR tool of FIG. 1, in accordance with an embodiment of the invention;

FIG. 15 is a diagram of a health care team interface page of the PHR tool of FIG. 1, in accordance with an embodiment of the invention;

FIG. 16 is a diagram of a health care tracking tool available to the patient via the PHR of FIG. 1, in accordance with an embodiment of the invention;

FIG. 17 is a diagram of a graphical output of an Alert Status report indicating the alert completion and outcome status for the overall patient population, in accordance with an embodiment of the invention;

FIG. 18 is a schematic illustrating an overview of a system for real-time processing and delivery of clinical alerts, personalized wellness alerts, and health risk score for the patient, in accordance with an embodiment of the invention;

FIG. 19 is a schematic of a real-time alert workflow processed by the alert payload filtering module of FIG. 18 with respect to a plurality of clinical alerts for a given patient, in accordance with an embodiment of the invention;

FIG. 20 is a schematic of exemplary real-time interactions of the health care organization of FIG. 18 with a plurality of external systems and applications via the real-time application messaging module, in accordance with an embodiment of the invention;

FIG. 21 is a flow chart of a method of providing real-time processing and delivery of clinical alerts, personalized wellness alerts, and health risk score of FIG. 18 to the patient and health care provider, in accordance with an embodiment of the invention;

FIG. 22 is a flow chart of a method for identifying and prioritizing patients that may benefit from care management in accordance with an embodiment of the invention;

FIG. 23 is a flow chart of a method for identifying specific conditions associated with a patient that may benefit from care management in accordance with an embodiment of the invention; and

FIG. 24 is a flow chart of a method for administering a care management in accordance with an embodiment of the invention.

### DETAILED DESCRIPTION OF THE INVENTION

The following embodiments further illustrate the invention but, should not be construed as in any way limiting the scope of the claims.

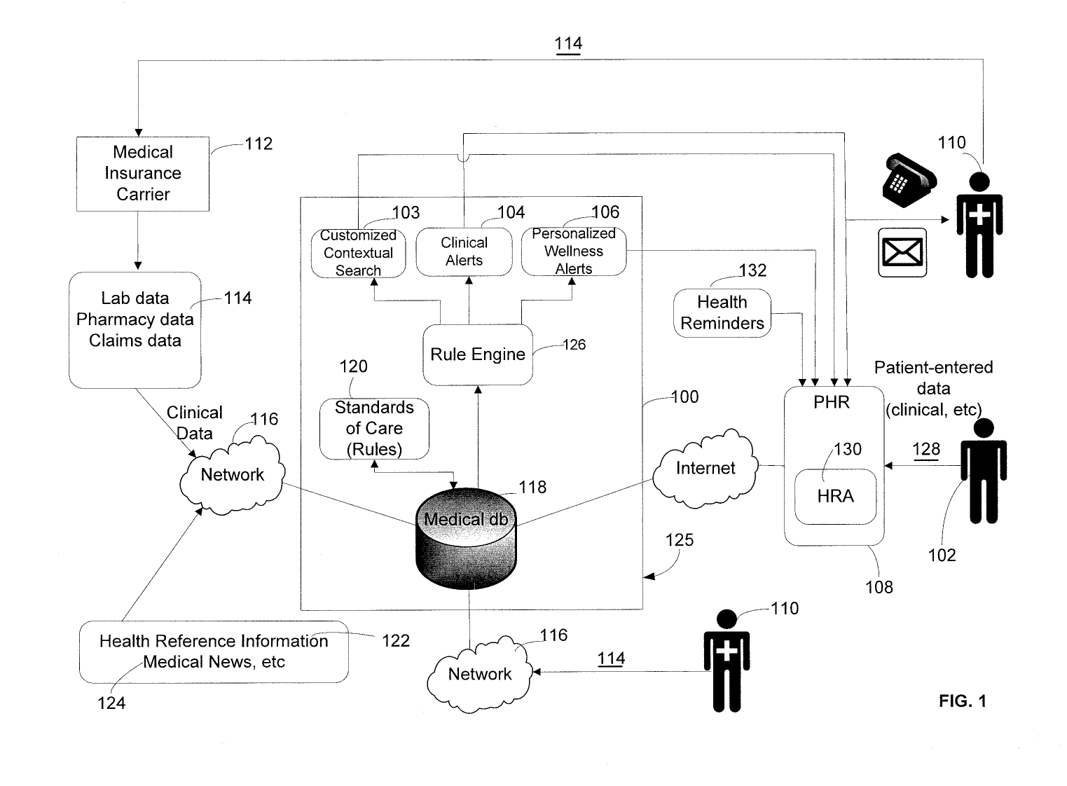

Turning to FIG. 1, an implementation of a system contemplated by an embodiment of the invention is shown with reference to an automated system for presenting a patient with an interactive personal health record powered by clinical decision support technology capable of delivering individualized alerts (including clinical alerts called Care Considerations) based on comparison of the best evidence-based medical standards of care to a patient's actual medical care. The health care organization 100 collects and processes a wide spectrum of medical care information relating to a patient 102 in order to generate and deliver customized alerts, including clinical alerts 104 and personalized wellness alerts 106, directly to the patient 102 via an online interactive personal health record (PHR) 108. In addition to aggregating patient-specific medical records and alert information, as well as other functionality to be discussed herein, the PHR 108 also solicits the patient's input for entering additional pertinent medical information, tracking of alert follow-up actions and allows the health care organization 100 to track alert outcomes.

When the patient 102 utilizes the services of one or more health care providers 110, a medical insurance carrier 112 collects the associated clinical data 114 in order to administer the health insurance coverage for the patient 102. Additionally, a health care provider 110, such as a physician or nurse, enters clinical data 114 into one or more health care provider applications pursuant to a patient-health care provider interaction during an office visit or a disease management interaction. Clinical data 114 originates from medical services claims, pharmacy data, as well as from lab results, and includes information associated with the patient-health care provider interaction, including information related to the patient's diagnosis and treatment, medical procedures, drug prescription information, in-patient information and health care provider notes. The medical insurance carrier 112 and the health care provider 110, in turn, provide the clinical data 114 to the health care organization 100, via one or more networks 116, for storage in a medical database 118. The medical database 118 is administered by one or more server based computers associated with the health care provider 100 and comprises one or more medical data files located on a computer readable medium, such as a hard disk drive, a CD-ROM, a tape drive or the like. The medical database 118 preferably includes a commercially available database software application capable of interfacing with other applications, running on the same or different server based computer, via a structured query language (SQL). In an embodiment, the network 116 is a dedicated medical records network. Alternatively or in addition, the network 116 includes an Internet connection which comprises all or part of the network.

An on-staff team of medical professionals within the health care organization 100 consults various sources of health reference information 122, including evidence-based preventive health data, to establish and continuously or periodically revise a set of clinical rules 120 that reflect best evidence-based medical standards of care for a plurality of conditions. The clinical rules 120 are stored in the medical database 118.

To supplement the clinical data 114 received from the insurance carrier 112, the PHR 108 allows patient entry of additional pertinent medical information that is likely to be within the realm of patient's knowledge. Exemplary patient-entered data 128 includes additional clinical data, such as patient's family history, use of non-prescription drugs, known allergies, unreported and/or untreated conditions (e.g., chronic low back pain, migraines, etc.), as well as results of self-administered medical tests (e.g., periodic blood pressure and/or blood sugar readings). Preferably, the PHR 108 facilitates the patient's task of creating a complete health record by automatically populating the data fields corresponding to the information derived from the medical claims, pharmacy data and lab result-based clinical data 114. In one embodiment, patient-entered data 128 also includes non-clinical data, such as upcoming doctor's appointments. Preferably, the PHR 108 gathers at least some of the patient-entered data 128 via a health risk assessment tool (HRA) 130 that requests information regarding lifestyle behaviors, family history, known chronic conditions (e.g., chronic back pain, migraines) and other medical data, to flag individuals at risk for one or more predetermined medical conditions (e.g., cancer, heart disease, diabetes, risk of stroke) pursuant to the processing by the rules engine module 126. Preferably, the HRA 130 presents the patient 102 with questions that are relevant to his or her medical history and currently presented conditions. The risk assessment logic branches dynamically to relevant and/or critical questions, thereby saving the patient time and providing targeted results. The data entered by the patient 102 into the HRA 130 also populates the corresponding data fields within other areas of PHR 108. The health care organization 100 aggregates the clinical data 114, patient-entered data 128, as well as the health reference and medical news information 122, 124, into the medical database 118 for subsequent processing via the rules engine module 126.

The CareEngine® System 125 is a multidimensional analytical software application including a rules engine module 126 comprising computer readable instructions for applying a set of clinical rules 120 to the contents of the medical database 118 in order to identify an instance where the patient's 102 actual care, as evidenced by the clinical data 114 and the patient-entered data 128, is inconsistent with the best evidence-based medical standards of care. After collecting the relevant data 114 and 128 associated with the patient 102, the rules engine module 126 applies the clinical rules 120 specific to the patient's medical data file, including checking for known drug interactions, to compare the patient's actual care with the best evidence-based medical standard of care. In addition to analyzing the claims and lab result-derived clinical data 114, the analysis includes taking into account known allergies, chronic conditions, untreated conditions and other patient-reported clinical data to process and issue condition-specific clinical alerts 104 and personalized wellness alerts 106 directly to the patient 102 via a set of Web pages comprising the PHR 108. The rules engine module 126 is executed by a computer in communication with the medical database 118. In one embodiment, the computer readable instructions comprising the rules engine module 126 and the medical database 118 reside on a computer readable medium of a single computer controlled by the health care organization 100. Alternatively, the rules engine module 126 and the medical database 118 are interfacing via separate computers controlled by the health care organization 100, either directly or through a network. Additional details related to the processing techniques employed by the rules engine module 126 are described in U.S. Pat. No. 6,802,810 to Ciarniello, Reisman and Blanksteen, which is incorporated herein by reference in its entirety.

To ensure prompt patient response, the health care organization 100 preferably sends concurrent email notifications to the patient 102 regarding availability of customized alerts 104 and 106 at the PHR 108. As described herein, the terms “alerts” and “customized alerts” refer to patient-specific health related notifications, such as clinical alerts 104 and personalized wellness alerts 106, which have been delivered directly to the patient 102 via the PHR 108 after being generated by the rules engine module 126 pursuant to the processing of one or more of the clinical data 114 and patient-entered data 128, and matched with the best evidence-based medical standards of care reflected in the clinical rules 120. In an embodiment, the alerts 104, 106 are also delivered to the health care provider 110. When the rules engine module 126 identifies an instance of actual care which is inconsistent with the best evidence-based medical standards of care, the patient 102 is presented with a clinical alert 104 via the PHR 108. Preferably, the clinical alerts 104 are prominently displayed within a user interface of the PHR 108. In embodiments, the clinical alerts 104 include notifications to contact the health care provider 110 in order to start or stop a specific medication and/or to undergo a specific test procedure associated with one or more conditions and co-morbidities specific to the patient 102. The clinical alerts 104 include notifying the patient regarding known drug interactions and suggested medical therapy derived from the current best evidence-based medical standard of care information 120. The clinical alerts 104 are also prompted by analysis of patient's medication regimen in light of new conditions and lab results. Similarly, the rules engine module 126 notifies the patient 102 regarding the clinically relevant preventive health information 122 by issuing personalized wellness alerts 106, via the PHR 108 to ensure overall consistency of care.

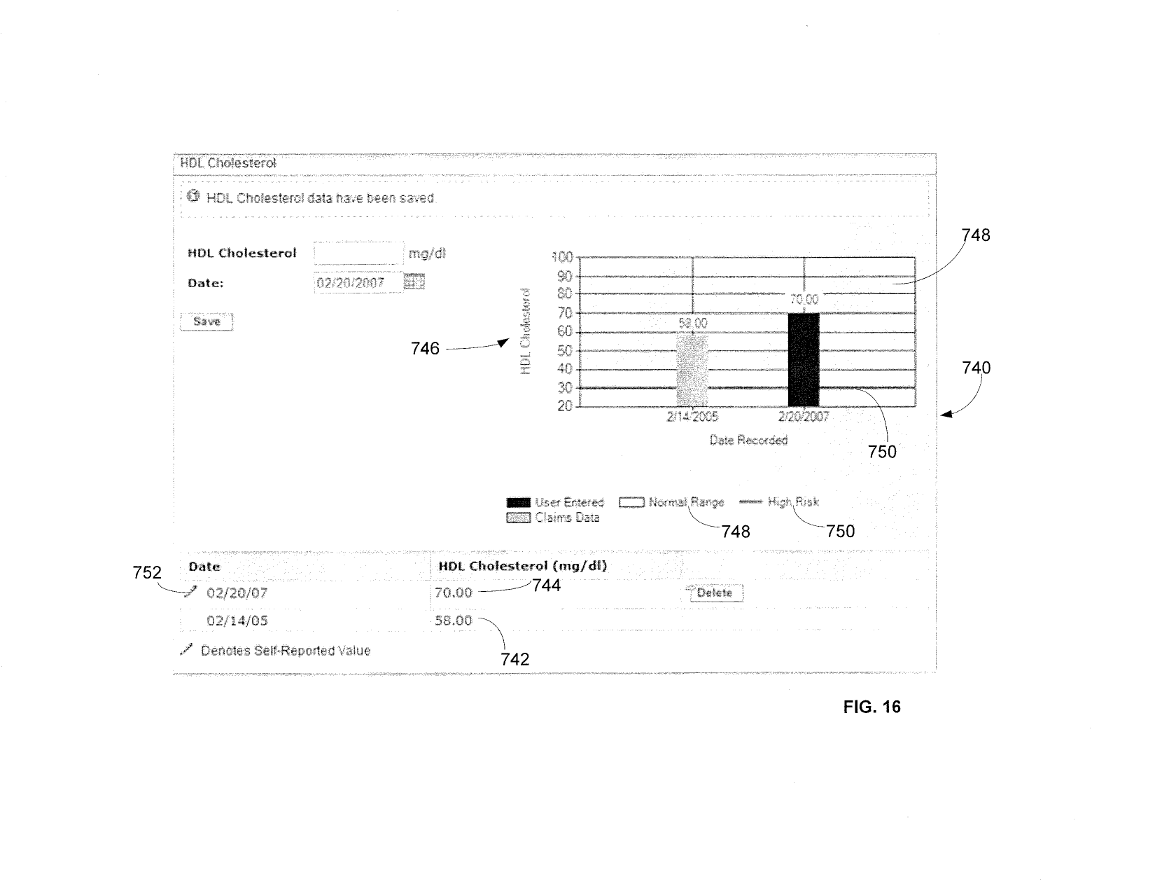

The rules engine also identifies the members who have at risk lifestyle behaviors (e.g., smoking, high stress, poor diet/exercise) and seeks consent from the high risk members to enroll them in a lifestyle coaching program. In one embodiment, the patient 102 is able to use the PHR 108 to search for specific health reference information regarding a specified condition, test or medical procedure by querying the medical database 118 via a user interface. In another embodiment, the patient 102 subscribes to medical news information 124 for delivery via the PHR 108 and/or personal email. In yet another embodiment, the rules engine module 126 automatically generates a customized contextual search 103 of the health reference information 122, medical news 124, and/or an external source of medical information, based on the patient's clinical data 114 and patient-entered data 128 for delivery of the search results via the PHR 108. In yet another embodiment, the patient 102 receives general health reminders 132 based on non-clinical components of the patient-entered data 128 that are not processed by the rules engine module 126, such as notifications regarding upcoming doctor appointments. In embodiments, the general health reminders 132 include prompting the patient 102 to update the HRA 130, watch a video tour of the PHR website, or update the health tracking information (discussed below in connection with FIG. 16). Preferably, the PHR 108 allows the patient 102 to create printable reports containing the patient's health information, including health summaries and health risk assessment reports, for sharing with the health care provider 110.

To ensure further follow-up, the health care organization 100 optionally notifies the health care provider 110 regarding the outstanding clinical alerts 104, as disclosed in the incorporated U.S. Pat. No. 6,802,810. For example, if a clinical alert 104 includes a severe drug interaction, the health care organization 100 prompts the health care provider 110, via phone, mail, email or other communications, to initiate immediate follow-up.

While the entity relationships described above are representative, those skilled in the art will realize that alternate arrangements are possible. In one embodiment, for example, the health care organization 100 and the medical insurance carrier 112 is the same entity. Alternatively, the health care organization 100 is an independent service provider engaged in collecting, aggregating and processing medical care data from a plurality of sources to provide a personal health record (PHR) service for one or more medical insurance carriers 112. In yet another embodiment, the health care organization 100 provides PHR services to one or more employers by collecting data from one or more medical insurance carriers 112.

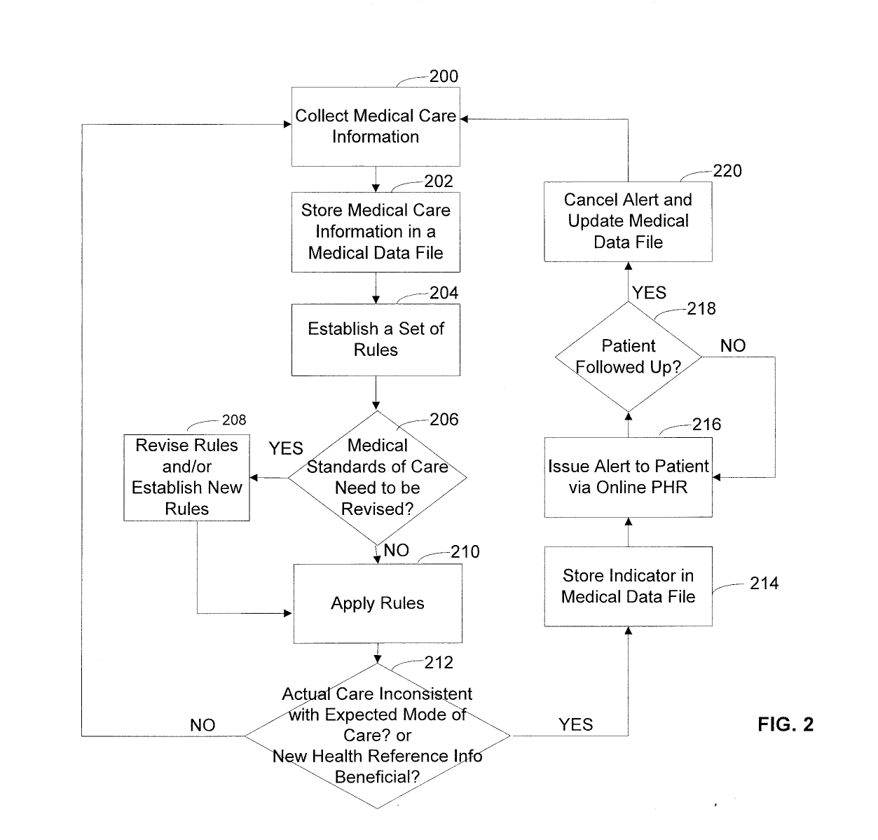

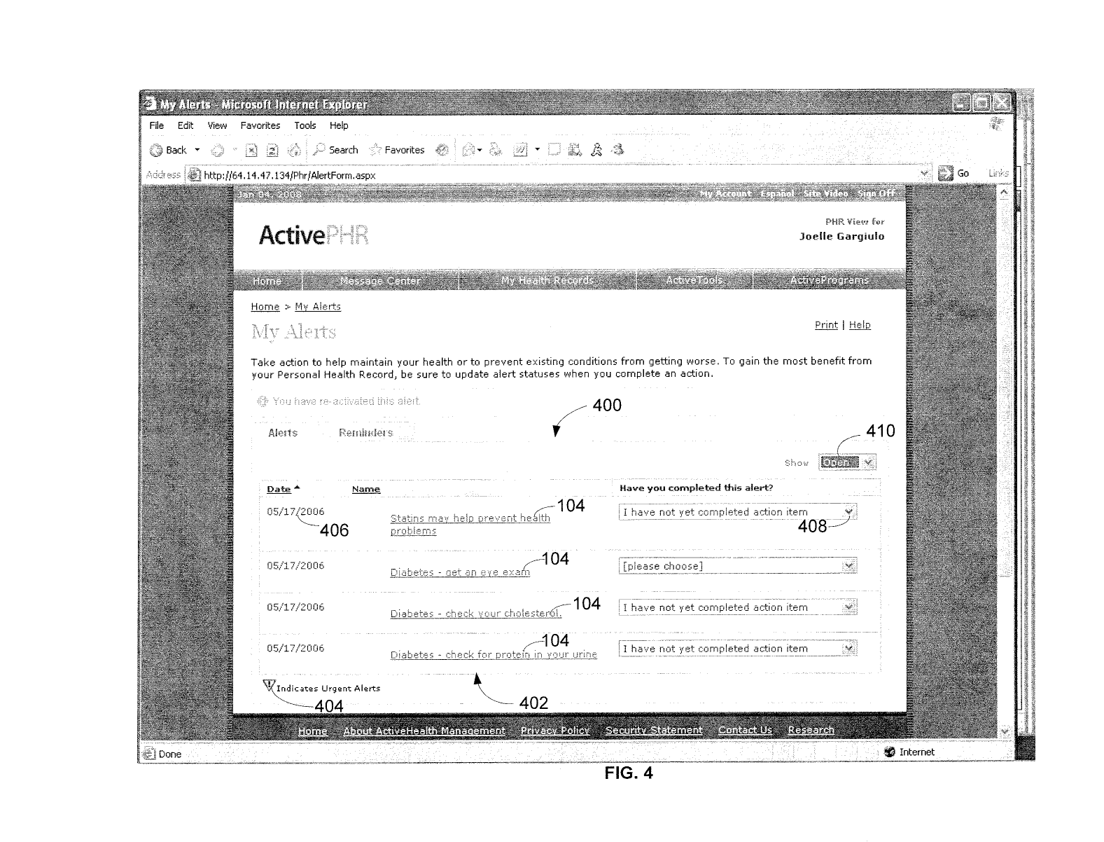

Turning to FIG. 2, a method for providing customized alerts to an individual patient via a personal health record is described. In steps 200-202, the health care organization 100 collects a wide spectrum of medical care information 114, 122, 124, 128 and aggregates it in the medical database 118 for subsequent analysis. In step 204, the health care organization 100 establishes a set of clinical rules 120 for a plurality of conditions, such as by having an on-site medical professional team continuously review collected health reference information 122, including evidence-based medical literature. In steps 206-208, when updates to the medical standards of care become available (e.g., upon collecting additional or updated evidence-based literature), the health care organization 100 revises the clinical rules 120 and builds new rules associated with the best evidence-based medical standards of care. In steps 210 and 212, the rules engine module 126 applies the latest evidence-based medical standards of care included within the clinical rules 120 to the patient's actual care, as evidenced from the claims, pharmacy, lab and patient-entered clinical data, to identify at least one instance where the patient's actual care is inconsistent with the expected care embodied by the clinical rules 120. Step 212 further includes identifying whether the patient 102 should be notified about newly available evidence-based standards of preventive health care 122 via a personalized wellness alert, such as when the preventive health care information is beneficial to the patient's actual care (e.g., notifications regarding the benefits of breast cancer screening). If the rules engine module 126 does not detect a discrepancy between the actual care given by the caregiver and the best evidence-based medical standards of care, or when the newly received health reference is not beneficial (e.g., cumulative in light of existing information), the method returns to step 200. Otherwise, in steps 214-216, the rules engine module 126 stores an alert indicator in the patient's 102 medical data file within the medical database 118, including the associated alert detail, and presents the patient with one or more clinical alerts 104 and/or personalized wellness alerts 106 via the appropriate interface of the PHR 108. Optionally, the rules engine module 126 notifies the patient 102, via email or otherwise, to log into the PHR 108 in order to view one or more issued alerts 104, 106. As discussed in further detail in connection with FIG. 4 below, the PHR 108 provides the patient 102 with an opportunity to update the system with status or outcome of the alert follow-up. To that end, if the patient 102 indicates that the alert has been addressed, the PHR 108 will update the corresponding alert indicator in the medical database 118 with the follow-up status or outcome, steps 218 and 220. In one embodiment, the system also automatically updates an alert indicator based on becoming aware of alert follow-up via changes present in incoming clinical data 114. For example, when incoming lab, pharmacy, and/or medical services claim data indicates that the patient followed up on a previously issued alert by undergoing a suggested test procedure, modifying a prescription, and/or consulting a health care provider, the system automatically updates the alert follow up status display at the PHR 108. Otherwise, the PHR 108 continues to prompt the patient 102 to follow-up on the alert.

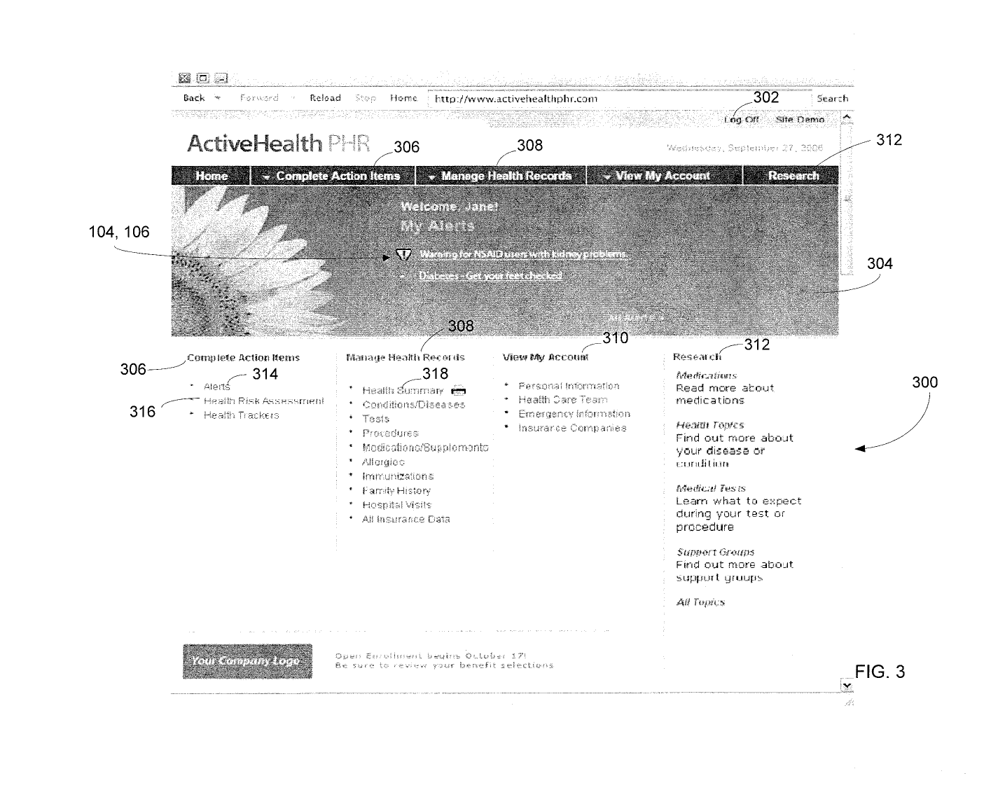

FIGS. 3-17 below provide additional detail regarding various embodiments of the PHR 108 and its associated functionality. Turning to FIG. 3, an embodiment of the main page 300 of the PHR 108 is shown. In one embodiment, when the patient 102 obtains access to the PHR 108 via a secure login/logoff area 302, the PHR 108 presents the patient with an alert display area 304 having one or more selectable alerts 104, 106 which are awaiting the patient's follow-up. The main page 300 further includes a plurality of links generally related to alert follow-up and health risk assessment (HRA) 306, health record management 308, account administration 310 and online health library access 312. While the PHR 108 pre-populates some patient information using the clinical data received from the medical insurance carrier 112, patient-entered data comprises an important part of the overall record. Therefore, embodiments of the invention include providing incentives to the patient 102 in order to elicit a complete response to the patient-entered data fields, such as those in the HRA 130 and, optionally, to ensure alert follow-up. In one embodiment, the incentives include a points program administered by the patient's employer or by the health care organization 100.

Upon selecting the alerts link 314 or any of the pending alerts 104, 106 displayed in the alerts display area 304, the patient 102 is directed to the alerts detail page 400, as illustrated in FIG. 4. The alerts detail page 400 presents the patient with an alerts list 402, which includes alerts pending the patient's follow-up and is preferably pre-sorted by urgency level 404 and notification date 406. In the illustrated embodiment of FIG. 4, the alerts list 402 includes a number of clinical alerts 104 suggesting specific tests related to patient's diabetes and recommending use of statins (e.g., to lower cholesterol levels). In one embodiment, the list 402 includes one or more personalized wellness alerts 106, such a recommendation to undergo periodic breast cancer screenings for female patients of predetermined age range that have not had a recent screening. The list 402 further includes an alert completion status dropdown list 408 to provide the health care organization 100 with follow-up status as to the issued alerts 104, 106. The alert completion status dropdown list 408 allows the patient 102 to indicate whether a specific alert has been completed and, if so, to select additional detail related to the completion outcome. In this embodiment, the dropdown list 408 includes choices indicating that the patient has contacted the health care provider 110 to start or stop the flagged medication, and/or complete the flagged test. Additionally, the list 408 allows the patient to provide reasons for not completing a pending alert, such as by indicating that the patient is still planning to discuss the alert with the health care provider 110, that the patient is allergic or otherwise intolerant to the suggested medication or test procedure, that the patient cannot afford the suggested treatment or that the alert is otherwise not applicable. The alerts interface 400 further includes an alert status dropdown list 410 to allow the patient 102 to separately view and update open and completed alerts.

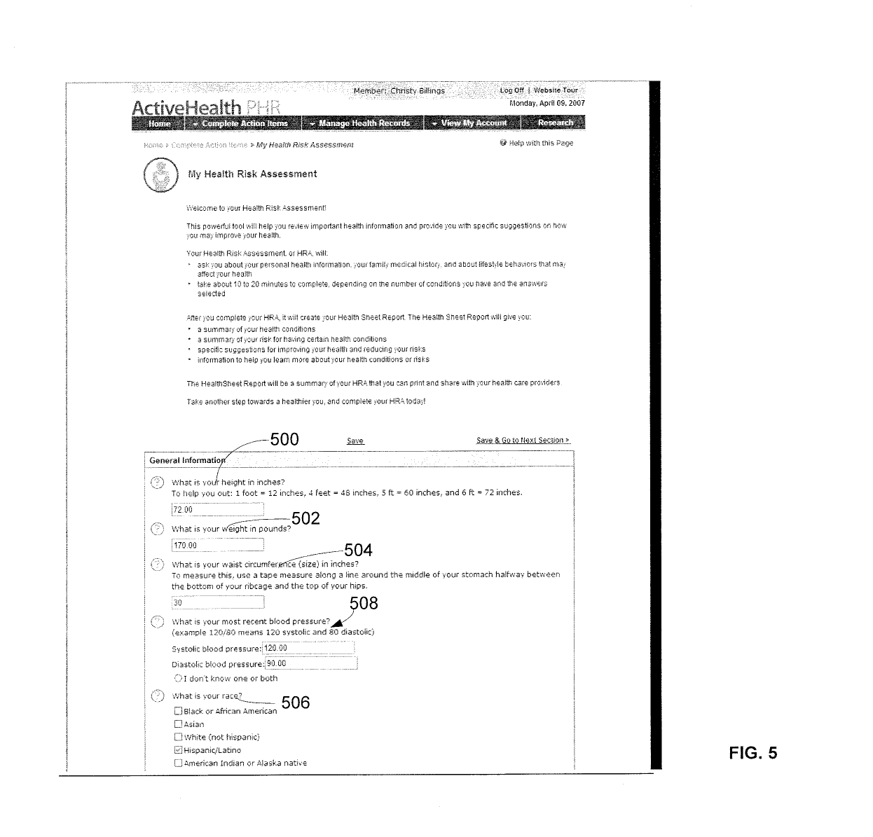

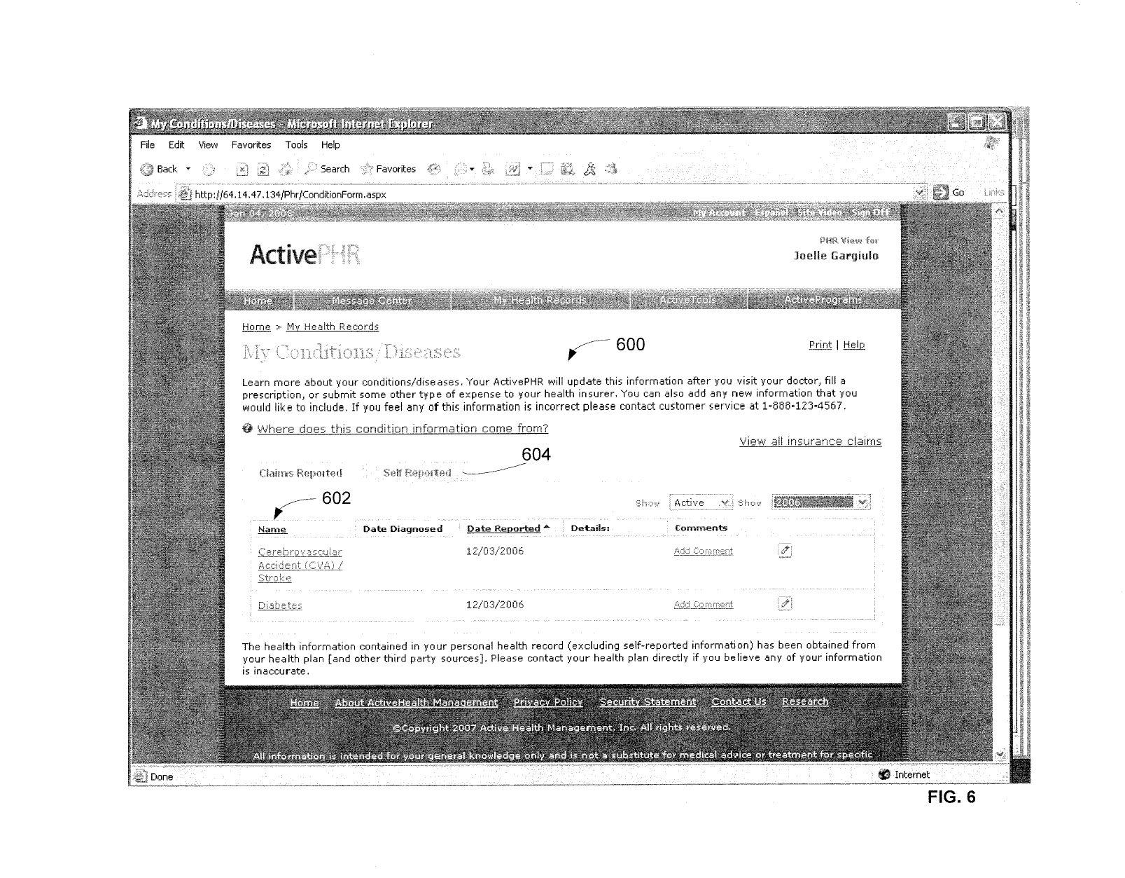

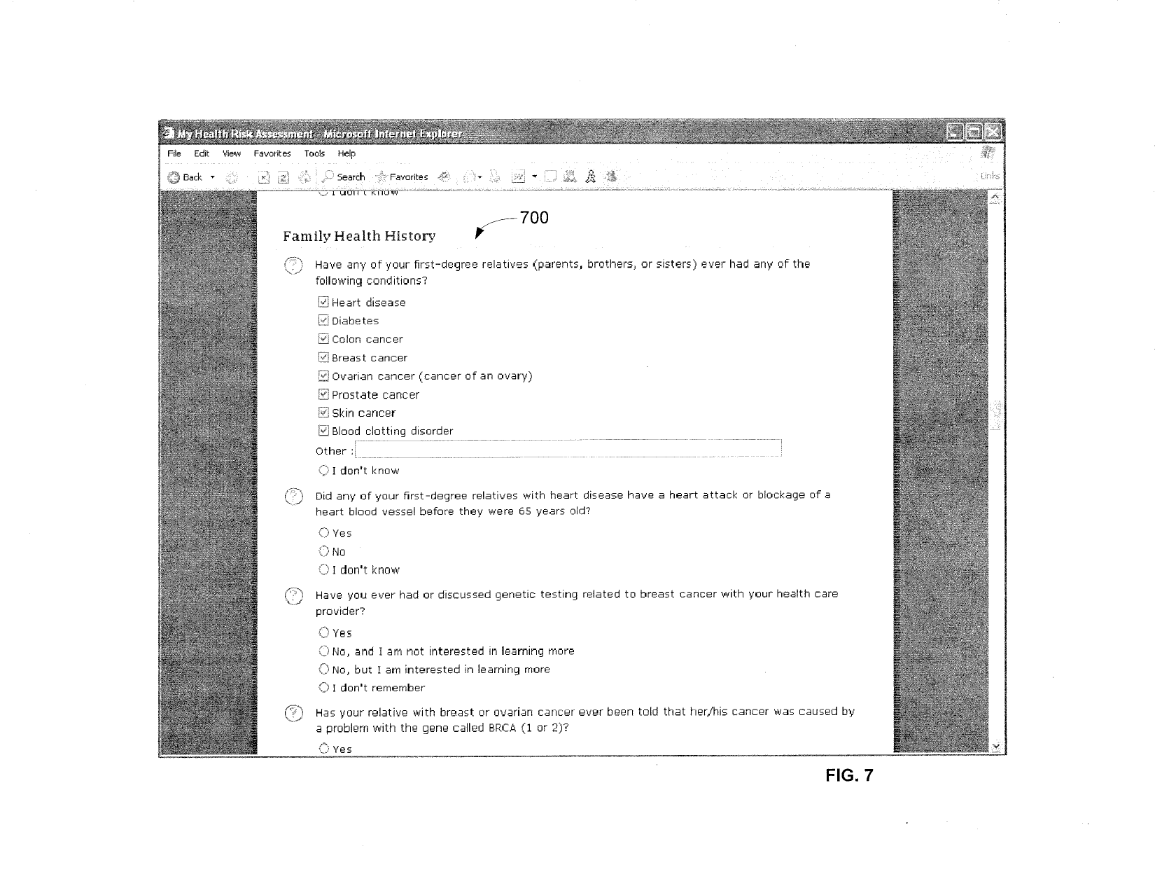

The PHR 108 main page 300 (FIG. 3) also includes a link 316 to the HRA 130, which allows the health care organization 100 to gather additional data 128 from the patient 102 to perform analysis for identifying individuals at risk for one or more predetermined medical conditions. As illustrated in FIGS. 5-7, the HRA 130 combines clinical data derived from health insurance carrier 112 with patient-entered personal health information, family medical history, unreported medical conditions, lifestyle behaviors, and other information to provide the patient 102 with specific health improvement suggestions to discuss with the health care provider along with clinical alerts 104 and personalized wellness alerts 106. As seen in FIG. 5, the HRA interface 130 initially prompts the patient 102 to enter general information, such as height 500, weight 502, waist circumference 504, race 506, and recent blood pressure readings 508 prior to presenting the patient 102 with a conditions/diseases interface 600 (FIG. 6). The conditions/diseases interface 600, in turn, allows the patient to view and update pre-populated conditions 602 based on insurance carrier clinical data 114 previously validated and analyzed by the rules engine module 126. The HRA 130 also allows the patient 102 to enter self-reported health problems 604 that the health care provider 110 is not aware of and/or health problems which the patient 102 is self-treating, such as upset stomach, back pain, or a headache. In one embodiment, the patient 102 is able to opt out from displaying at least some conditions within the conditions and symptoms interface 600, such as to provide a health care provider 110 with a customized printout of patient's conditions. As shown in FIG. 7, patient-entered family history information 700 helps predict the risk associated with certain hereditary diseases. Information entered into the HRA 130 cross-populates other areas of the PHR 108 and vice-versa.

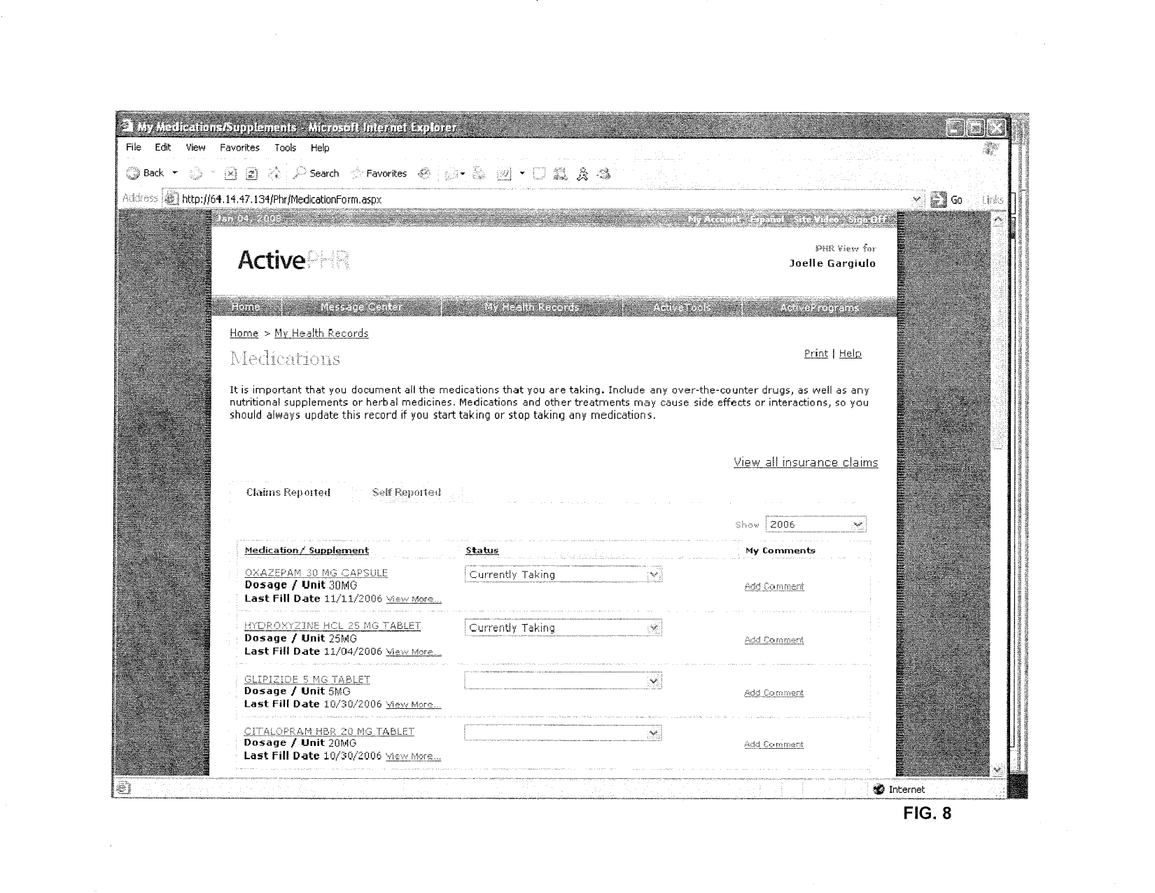

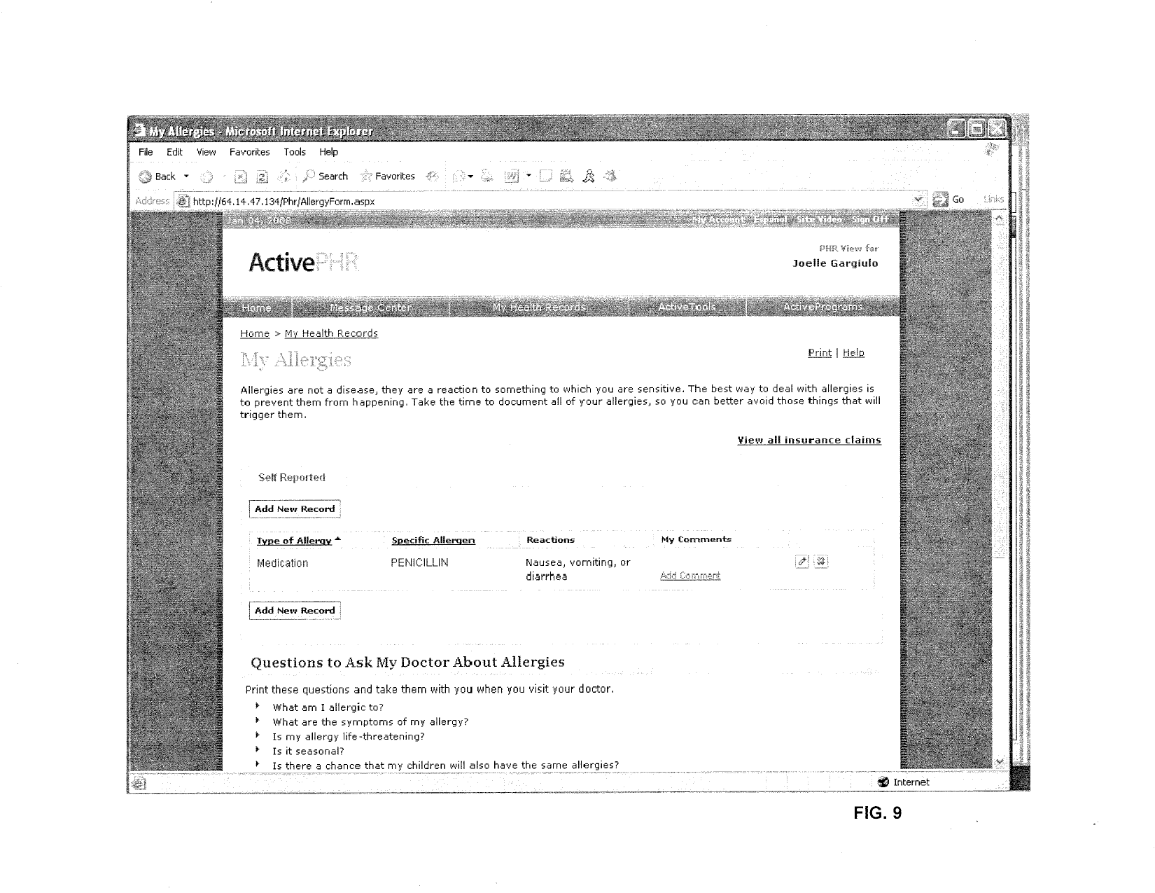

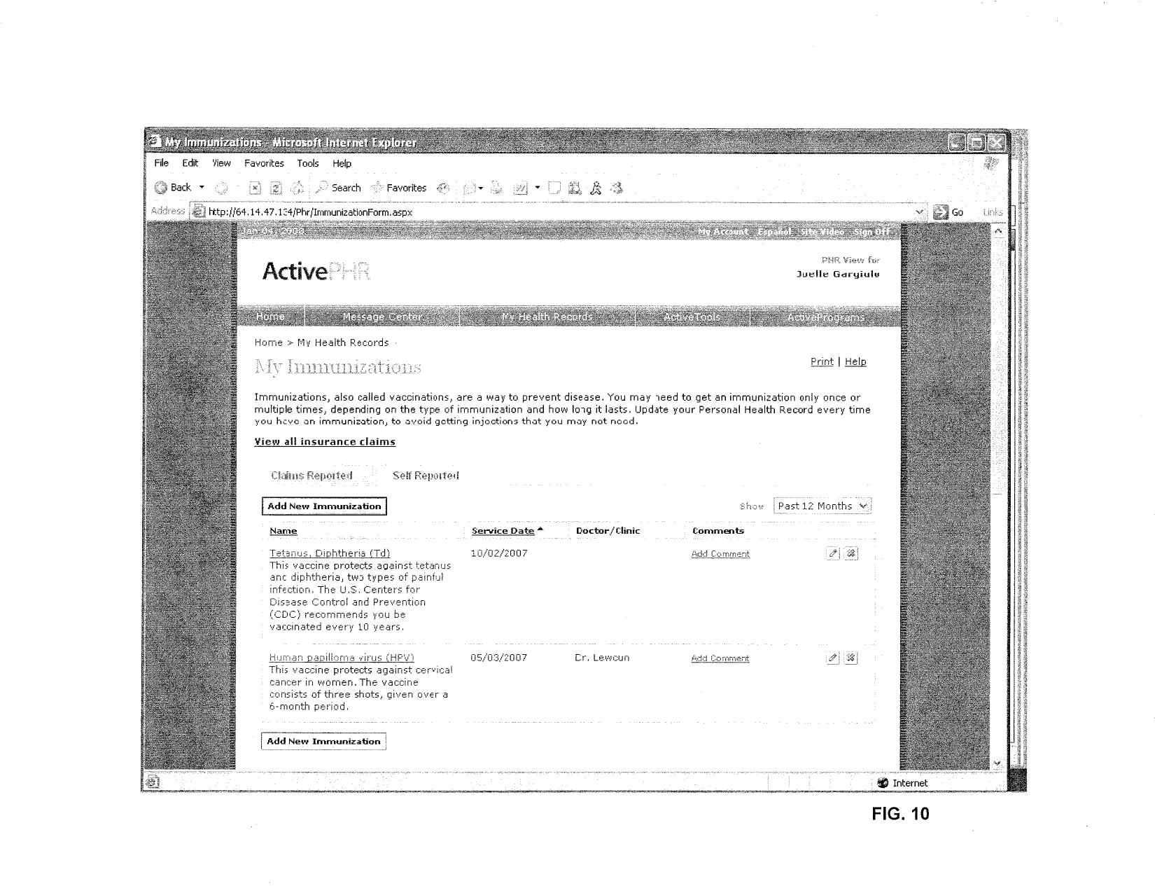

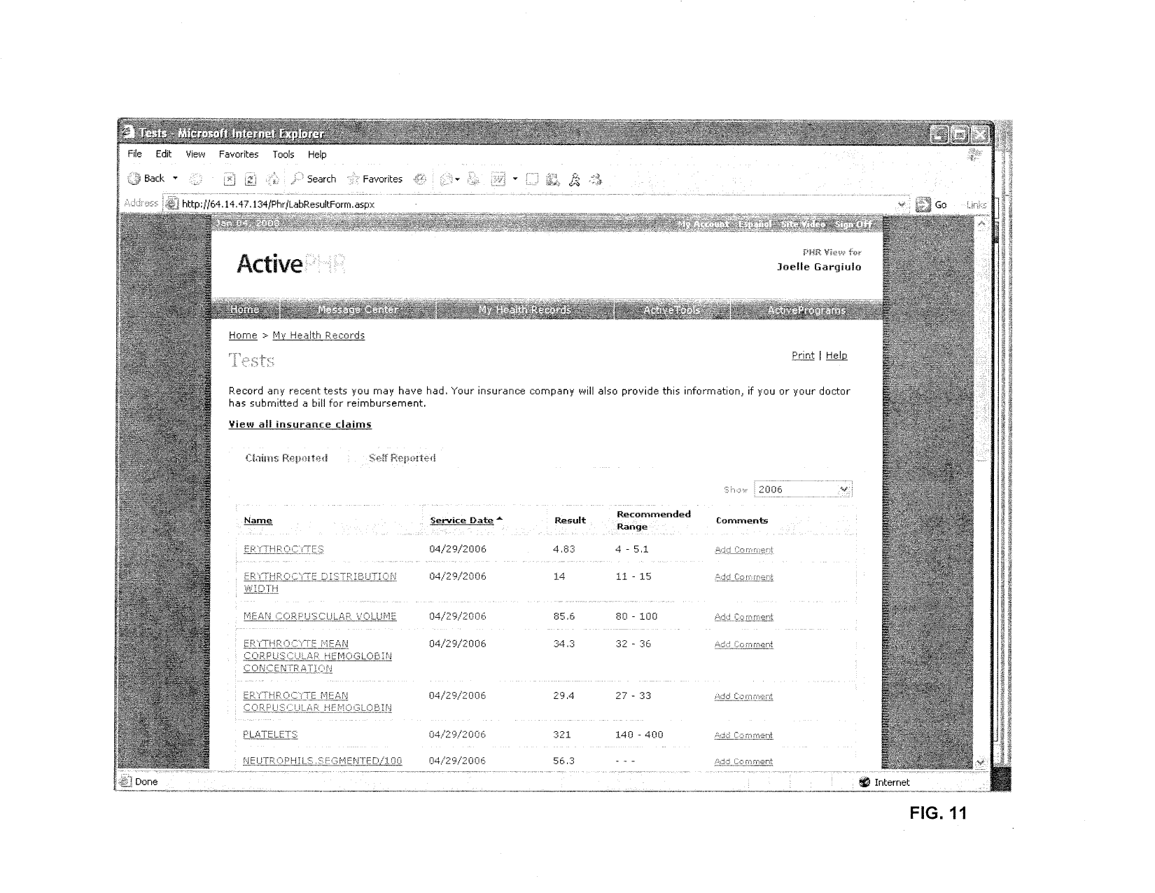

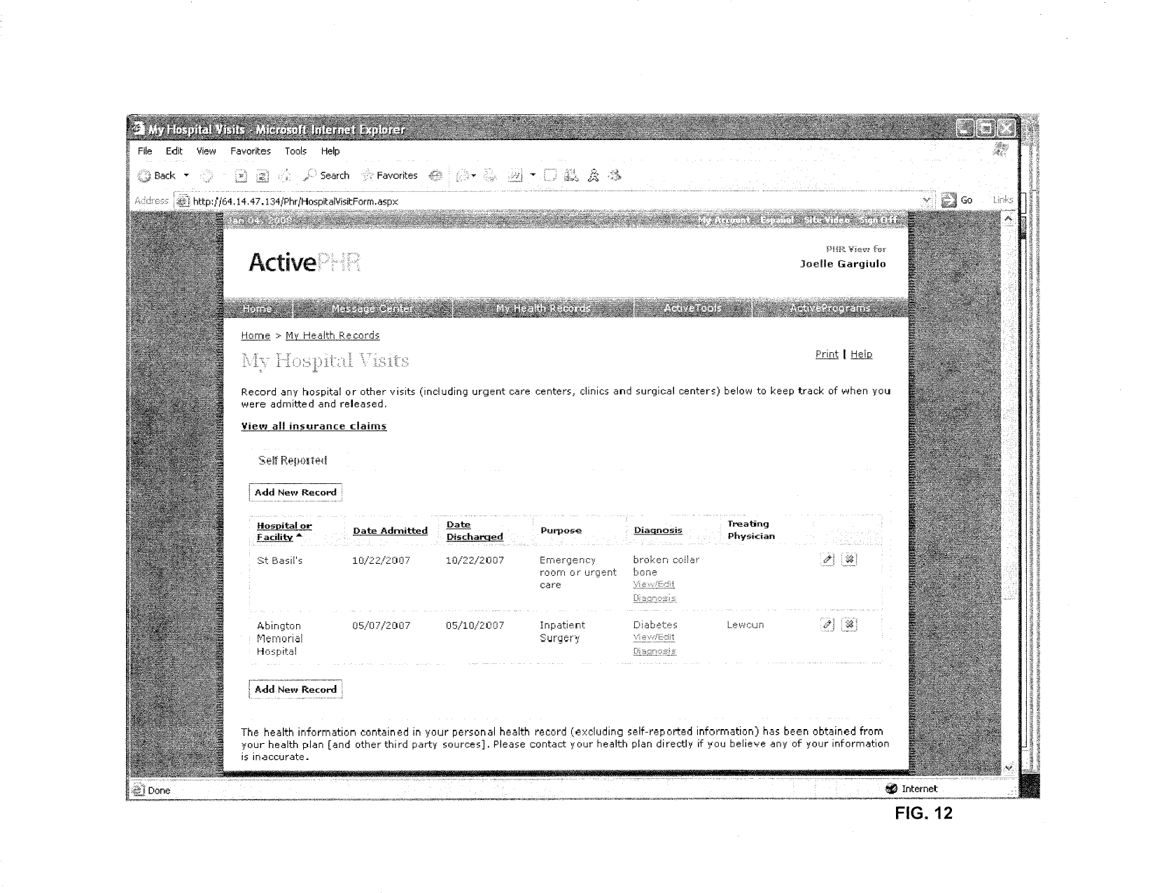

As illustrated in FIGS. 8-12, other areas of PHR 108 permit the patient 102 to enter and view prescription and non-prescription medication and supplements (FIG. 8), list allergies and associated allergy triggers (FIG. 9), update an immunization list (FIG. 10), and create a record of tests, procedures, and hospital visits (FIGS. 11, 12).

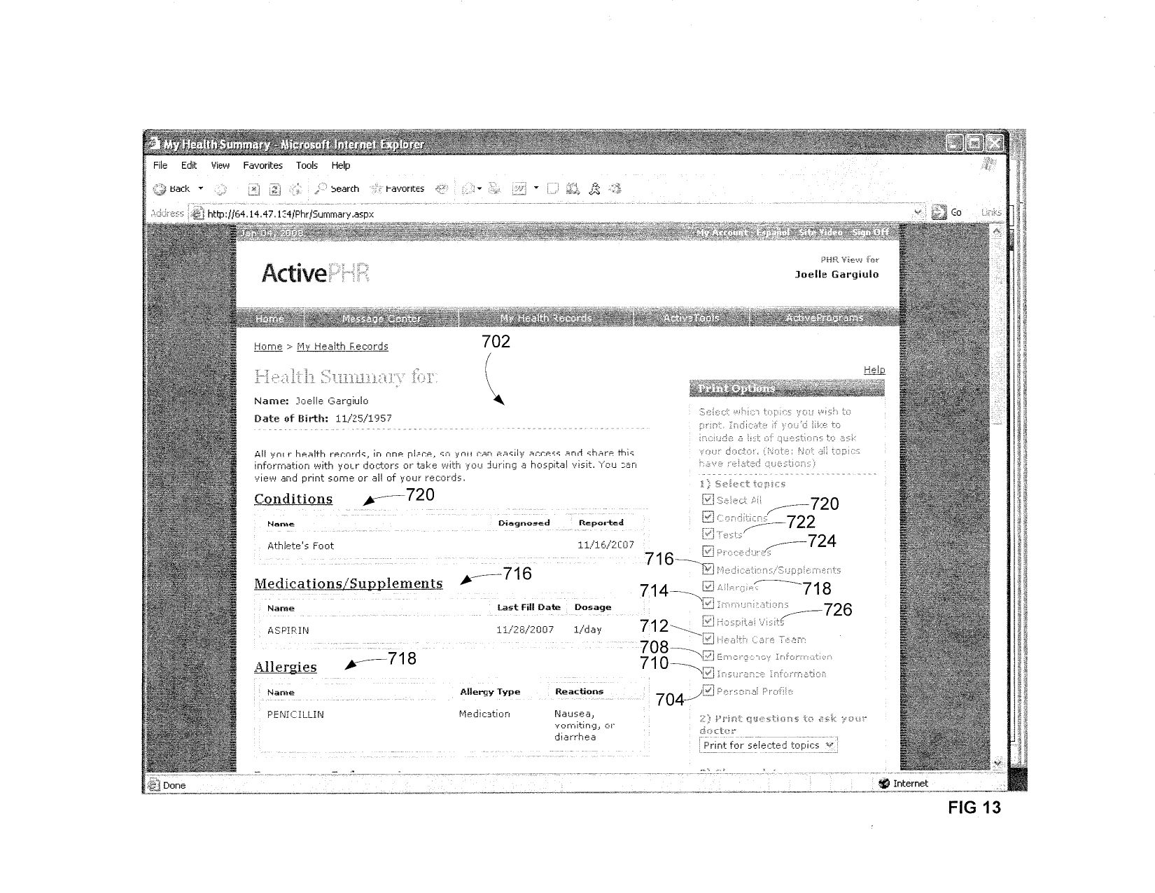

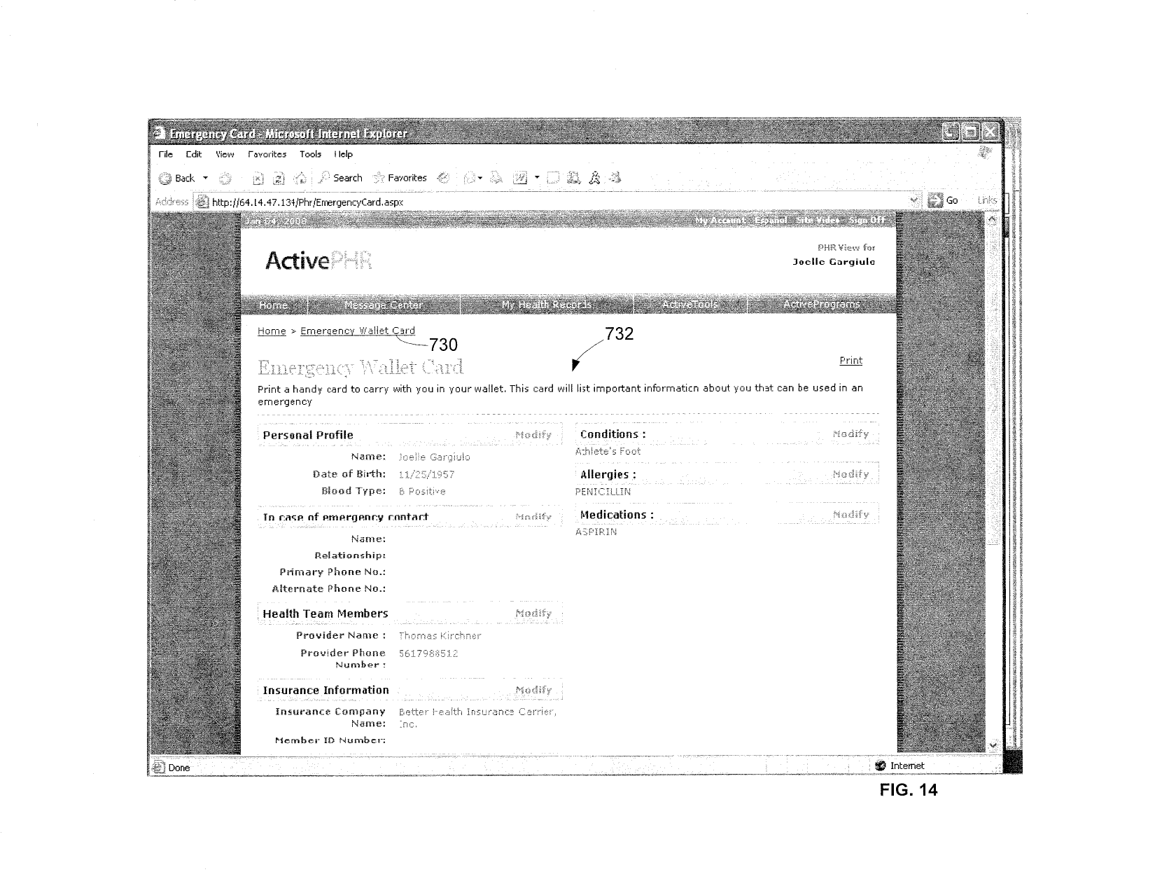

To view a summary of some or all of the information available via FIGS. 5-12, the PHR 108 includes a link 318 (FIG. 3) to a health summary page 702. As shown in FIG. 13, the health summary interface 702 is used by the patient 102 to share an overview of his or her health with a health care provider 110 during visits to the doctor's office or hospital. The health summary 702 includes both claim-derived and patient-entered data. Specifically, the health summary 702 allows the patient 102 to individually select for display one or more of the following categories of information: patient's personal information 704, emergency contacts 708, insurance provider contact information 710, health care team 712 (such as treating physicians and preferred pharmacies), immunizations 714, prescription and over-the-counter medications 716, allergies 718, conditions 720 (including potential conditions based on the clinical data analyzed by the rules engine module 126), as well as tests, procedures, and hospital visit information 722-726. Conversely, the PHR 108 also allows the patient 102 to opt out from displaying at least some of the information in the health summary 702, so as to tailor the type of information displayed in this report for a specific health care provider 110, or to edit out certain sensitive information. In one embodiment, the PHR 108 allows the patient 102 to opt out from displaying some or all patient-entered information in the health summary 702, while always displaying the claim-derived data. Alternatively or in addition, the patient 102 is able to print some or all sections 706-726 of the health summary 702 for sharing with the health care provider 110. As all other information comprising the PHR 108, information that the patient 102 opts not to display in the health care summary 702 remains stored in the medical database 118 and available to the rules engine module 126 for deriving clinical alerts 104 and personalized wellness alerts 106. Furthermore, such information remains available for patient's viewing via other areas of the PHR 108, as described above in connection with FIGS. 5-12. As a further advantage, a more condensed summary of the information available via PHR 108 is available to the patient 102 via the link 730 in form of an emergency information card 732 (FIG. 14).

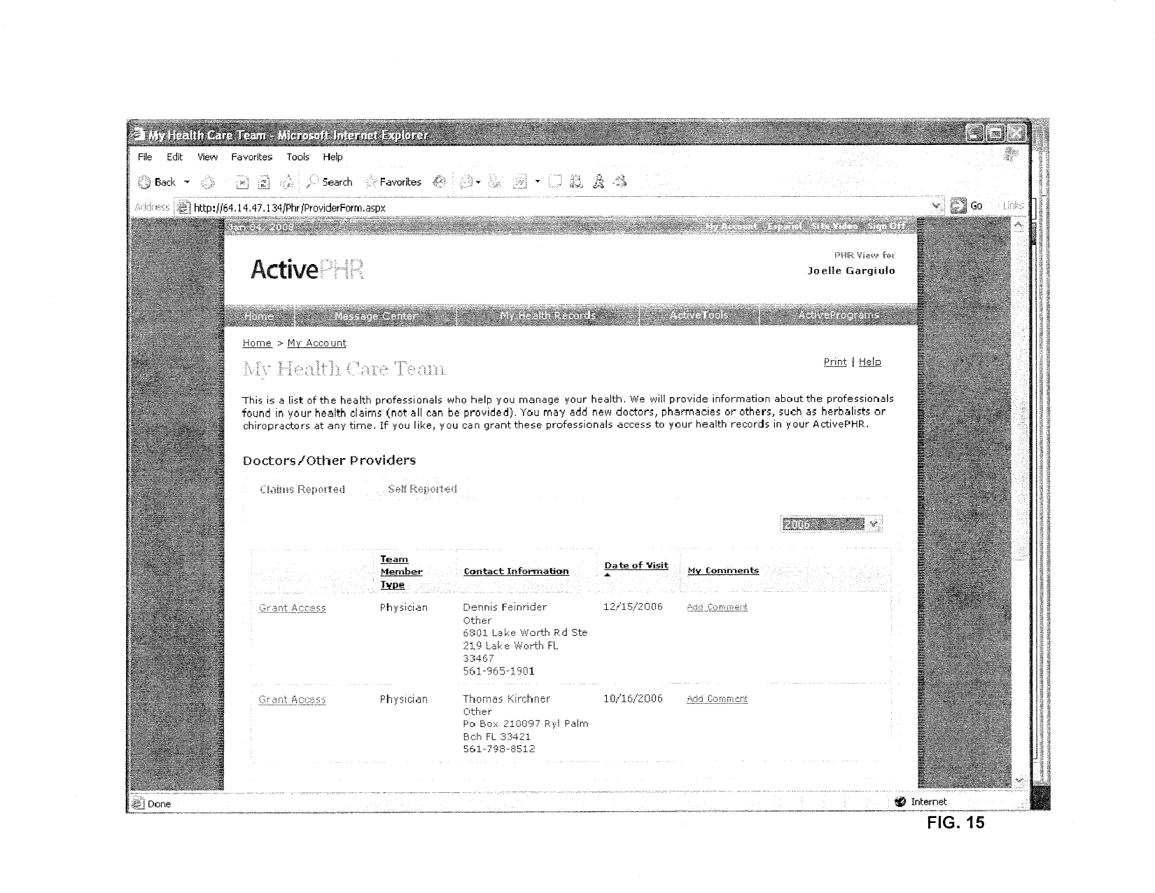

Preferably, the patient 102 supplements the health care team list 712 via a health care team page 734, as shown in FIG. 15. The health care team page 734 allows the patient 102 to add new doctors, pharmacies, chiropractors, other health care providers, and designate a primary physician at any time without waiting for the claim-populated information. Preferably, the patient 102 controls a health care provider's read and/or write access to the PHR 108 by assigning username and password to the provider of choice via the access link 736. The self-reported tab 738 includes a list of self-reported health care providers, while the claims reported tab 739 includes a list of providers based on incoming claims data. In embodiments, the patient 102 allows one or more health care providers to access some or all of the information available via the PHR 108. Other embodiments include allowing family member or caregiver access to the PHR 108, as well as providing the patient 102 with access to personal health record information of a dependent. In yet another embodiment, the PHR 108 provides the patient 102 with a data import/export utility capable of porting the information comprising the PHR 108 between health care providers. Additional embodiments include allowing the patient 102 to delete the display of at least some health care providers from the list 712.

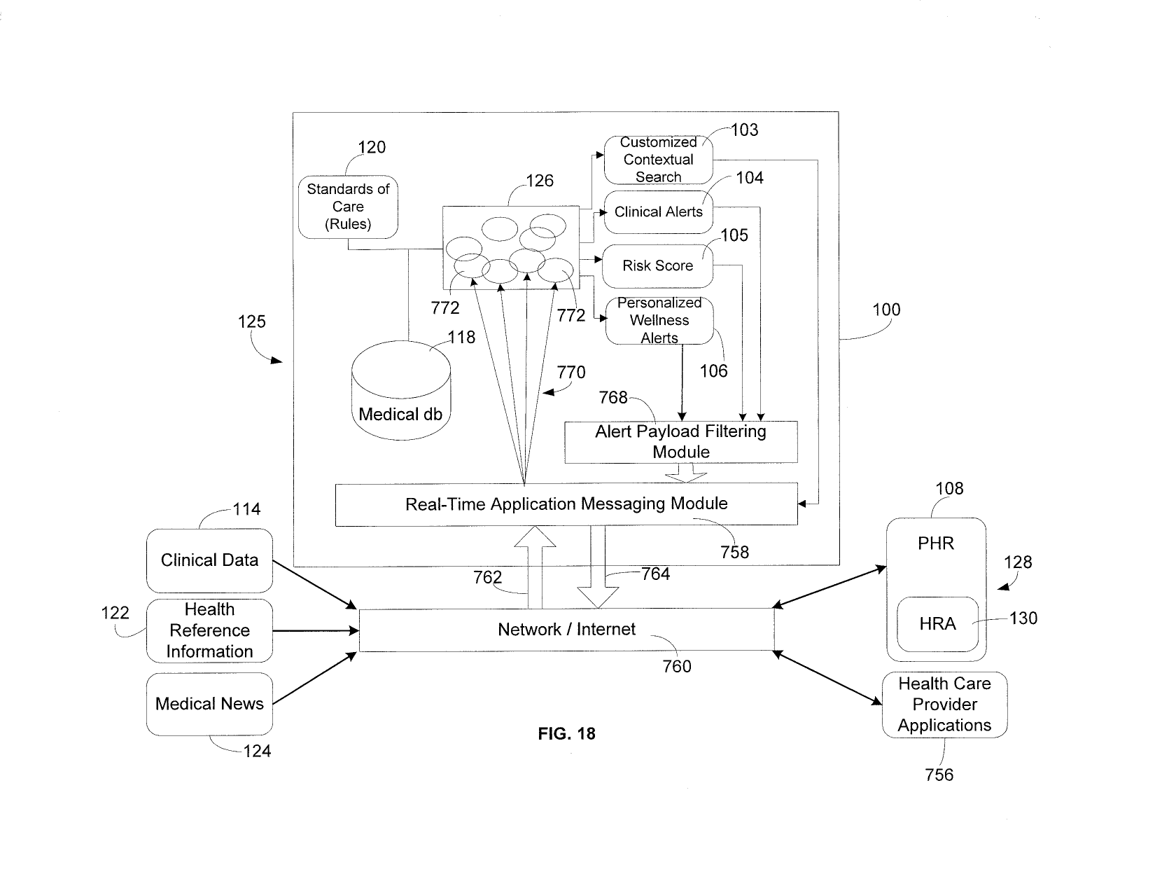

Turning to FIG. 16, the PHR 108 further includes a health tracking tool 740 to allow the patient 102 to trend one or more health indicators. In the illustrated embodiment, the health tracking tool 740 combines the claims data 742 with patient-reported data 744 (e.g., from the HRA 130 of FIG. 5) to provide the patient 102 with a graphical representation 746 of an HDL cholesterol trend. Additional embodiments of the health tracking tool 740 include tracking other health indicators capable of periodic evaluation, such as blood pressure, for example. The rules engine module 126 evaluates the patient-reported and claims based health tracker data along with other clinical data available in the medical database 118 to determine the patient specific goal for a given tracker metric and evaluate the current tracker value against that goal to trigger a clinical alert 104 to the patient. In embodiments of FIGS. 18-21 below, the clinical alert 104 associated with the current tracker value is delivered to the health tracking tool 740 in real-time. Preferably, the graphical representation area 746 includes normal range and high risk indicators 748, 750 to provide the patient 102 with a health risk assessment trend. Self-reported values are represented via a self-reported indicator 752.

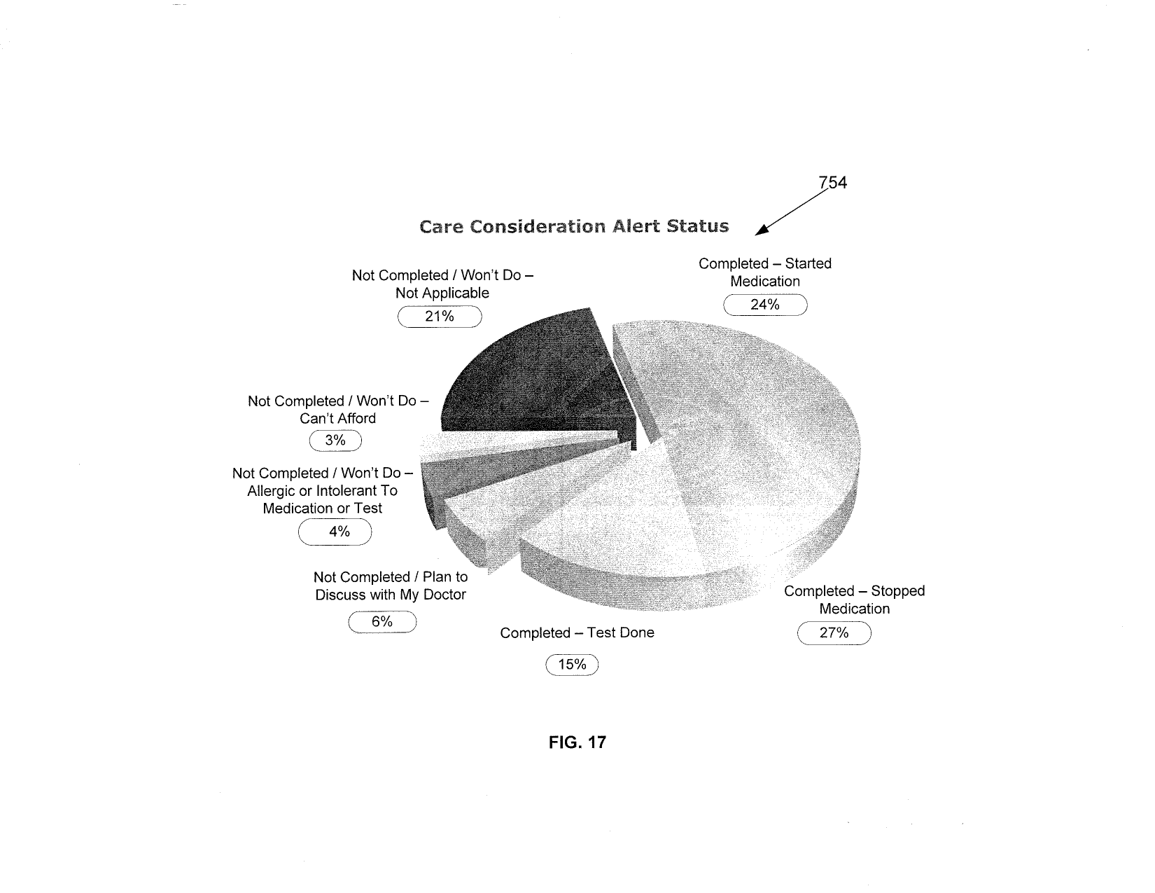

As shown in FIG. 17, the health care organization 100 tracks the alert outcome for the overall patient population by querying the patient-entered alert status stored in the medical database 118. In the illustrated embodiment, the alert status report 754 indicates the clinical alert completion status for the overall patient population as selected by each individual patient 102 via the alert completion status dropdown list 408 (FIG. 4) of the PHR 108. Other embodiments include providing PHR utilization reports to employers for gauging employee participation.

Additional embodiments of the PHR 108 include using the PHR interface to display employer messages, as well as providing secure messaging between the patient 102 and a health care provider 110 via the PHR.

In the additional embodiments illustrated in FIGS. 18-21 the system and method of the present invention implements a plurality of modules for providing real-time processing and delivery of clinical alerts 104 and personalized wellness alerts 106 to the patient 102 via the PHR 108 and to a health care provider 110 via one or more health care provider applications 756. Turning to FIG. 18, the modules 758, 768 comprise computer executable instructions encoded on a computer-readable medium, such as a hard drive, of one or more server computers controlled by the health care organization 100. Specifically, the system includes a real-time application messaging module 758 for sending and receiving real-time information via a network 760 between the health care organization 100 and external systems and applications. Preferably, the real-time application messaging module 758 employs a service-oriented architecture (SOA) by defining and implementing one or more application platform-independent software services to carry real-time data between various systems and applications.

In one embodiment, the real-time application messaging module 758 comprises web services 762, 764 that interface with external applications for transporting the real-time data via a Simple Object Access Protocol (SOAP) over HTTP. The message ingest web service 762, for example, receives real-time data which is subsequently processed in real-time by the rules engine module 126 against the best evidence-based medical standards of care 120. The message ingest web service 762 synchronously collects clinical data 114 from the medical insurance carrier 112, patient-entered data 128, including patient-entered clinical data, from the patient's PHR 108 and HRA 130, as well as health reference information and medical news information 122, 124. In an embodiment, the message ingest web service 762 also receives clinical data 114 in real-time from one or more health care provider applications 756, such as an electronic medical record application (EMR) and a disease management application. In yet another embodiment, the message ingest service 762 receives at least some of the patient-entered data 128 pursuant to the patient's interaction with a nurse in disease management or an integrated voice response (IVR) system. Incoming real-time data is optionally stored in the medical database 118. Furthermore, incoming real-time data associated with a given patient 102, in conjunction with previously stored data at the database 118 and the clinical rules 120, defines a rules engine run 770 to be processed by the rules engine module 126. Hence, the real-time application messaging module 758 collects incoming real-time data from multiple sources and defines a plurality of rules engine runs 770 associated with multiple patients for real-time processing.

The real-time application messaging module 758 forwards the rules engine runs 770 to the rules engine module 126 to instantiate a plurality of patient-specific real-time rule processing sessions 772. The processing of the rule processing sessions 772 by the rules engine module 126 is load-balanced across multiple logical and physical servers to facilitate multiple and simultaneous requests for real-time matching of the clinical rules (best evidence-based medical standards of care) 120 against incoming clinical data 114 and patient-entered data 128. Preferably, the load-balancing of sessions 772 is accomplished in accordance with a J2EE specification. Each rule processing session 772 makes calls to the medical database 118 by referring to a unique member ID field for a corresponding patient 102 to receive the patient's clinical history and inherit the rules 120 for processing of incoming real-time data. When the actual mode of care for a given patient, as expressed by the clinical components of the incoming real-time data 114, 128 deviates from the expected mode of care, as expressed by the clinical rules 120, the rules engine module 126 generates one or more clinical alerts 104. The rules engine module 126 also generates real-time personalized wellness alerts 106 that are relevant to the patient. The rules engine module 126 makes service calls to the medical database 118 to store generated alerts 104, 106 and to provide updates on run status for each session 772. During processing, the rules engine module 126 records alert justification information in the medical database 118. In one embodiment, the alert justification information specifies which rules have been triggered/processed by the incoming data (e.g., by rule number), which alerts have been generated (e.g., by alert number), a time/date stamp for each alert 104, 106, the specific exclusionary and inclusionary information for a given patient that caused the rule to trigger (e.g., known drug allergies are used to exclude alerts recommending a drug regimen that may cause an allergic reaction), as well as the patient-entered and claim information associated with the incoming real-time data that triggered a given rule.

In an embodiment, the real-time application messaging module 758 employs a GetRTRecommendationForMember web service to trigger the real-time rule processing sessions 772 when a patient 102 saves data within the PHR 108, as well as upon receipt of other real-time medical care information 114, 122, 124 at the CareEngine® system 125. The request message structure of the GetRTRecommendationForMember web service comprises the following fields:

MemberPlanID—uniquely identifies a patient 102 within the medical database 118. In one embodiment, this field is derived from the patient's health care plan identification number.

ProcessCareConsideration—when this value is set to “True,” instructs the rules engine module 126 to instantiate one or more real-time rule processing sessions 772 based on the information comprising a corresponding care engine run 770. When this value is set to “False,” instructs the system to return all real-time alerts generated to date for the patient 102 without instantiating additional processing sessions 772.

The rules engine module 126 outputs real-time alerts 104, 106 via a response message of the GetRTRecommendationForMember web service, which comprises the following fields:

MemberPlanID—uniquely identifies a patient 102 within the medical database 118. In one embodiment, this field is derived from the patient's health care plan identification number.

MemberLangPref—may be set to either “English” or “Spanish,” depending upon the patient's language preference, as set at the PHR 108.

RTRecommendationList—a list of real-time alerts 104, 106 generated by the rules engine module 126, including an alert number, alert name, instructional text, severity code, creation date, and a completion status indicator (e.g., open, completed, ignore) for each generated alert.

In yet another embodiment, an on-staff team of medical professionals within the health care organization 100 employs a web-based rule maintenance application to manually define a set of clinical rules 120 to evaluate for a predetermined patient population. In this case, the health care organization 100 defines rules engine runs 770 by specifying a patient population, such as all or a subset of patients associated with a given health care plan or health care provider, as well as an execution version of the clinical rules 120, via the web-based rule maintenance application. The real-time application messaging module 758 then accumulates the rules engine runs 770 from the web-based rule maintenance application for real-time processing as described above.

In yet another embodiment, the rules engine module 126 applies clinical data 114 and clinical components of the patient-entered data 128 to generate a real-time risk score 105 for various medical conditions (e.g., points are assigned to various clinical factors that increase the risk for heart disease and based on the member's conditions and lifestyle behaviors, a percentage score is calculated to identify the member's risk for future heart disease). The risk score 105 quantifies the severity of existing medical conditions and assesses the risk for future conditions in light of evaluating multiple risk factors in accordance with the clinical rules 120. For example, the risk score 105 may identify high risk diabetics or patients subject to a risk of future stroke. The system presents the risk score 105 to the patient, as well as to the health care provider, such as to the nurse in a disease management program. For instance, upon completion of the HRA 130, the patient is immediately presented with a risk score 105 for potential and existing conditions. Additionally, the patient may request a risk score calculation directly via the PHR 130. In yet further embodiment, a clinician uses a disease management application/program to calculate the patient's risk score before and after a disease management interaction with the patient in order to assess progress. In another embodiment, a physician using an EMR application in an office setting may request a real-time risk score calculation for a patient during an appointment. This allows the physician to review the high risk factors in the patient's health regimen with the patient during an office visit and to identify patients requiring future disease management sessions.

The rules engine module 126 also generates a customized contextual search 103 of the health reference information 122, medical news 124, and/or external sources of medical information, based on the real-time input of patient's clinical data 114 and patient-entered data 128 for real-time delivery of the search results via the PHR 108.

Therefore, each rule processing session 772 produces a plurality of clinical alerts 104, personalized wellness alerts 106, calculates a risk score 105, and/or evaluates a real-time search 103 based on a set of real-time data 114, 122, 124, 128 for a given patient 102. The message transmit web service 764, in turn, delivers the generated alerts 104, 106 to the PHR 108 and/or health care provider applications 756, including disease management applications. Alternatively, the application messaging module 758 comprises a single web service for both sending and receiving real-time data. To facilitate the real-time delivery of alerts 104, 106 and to help focus the alert recipient's attention on clinically important alerts by removing clinically identical alerts, the alert payload filtering module 768 reduces the real-time alert payload by filtering the alert input to the real-time application messaging module 758 by a plurality of conditions and categories.

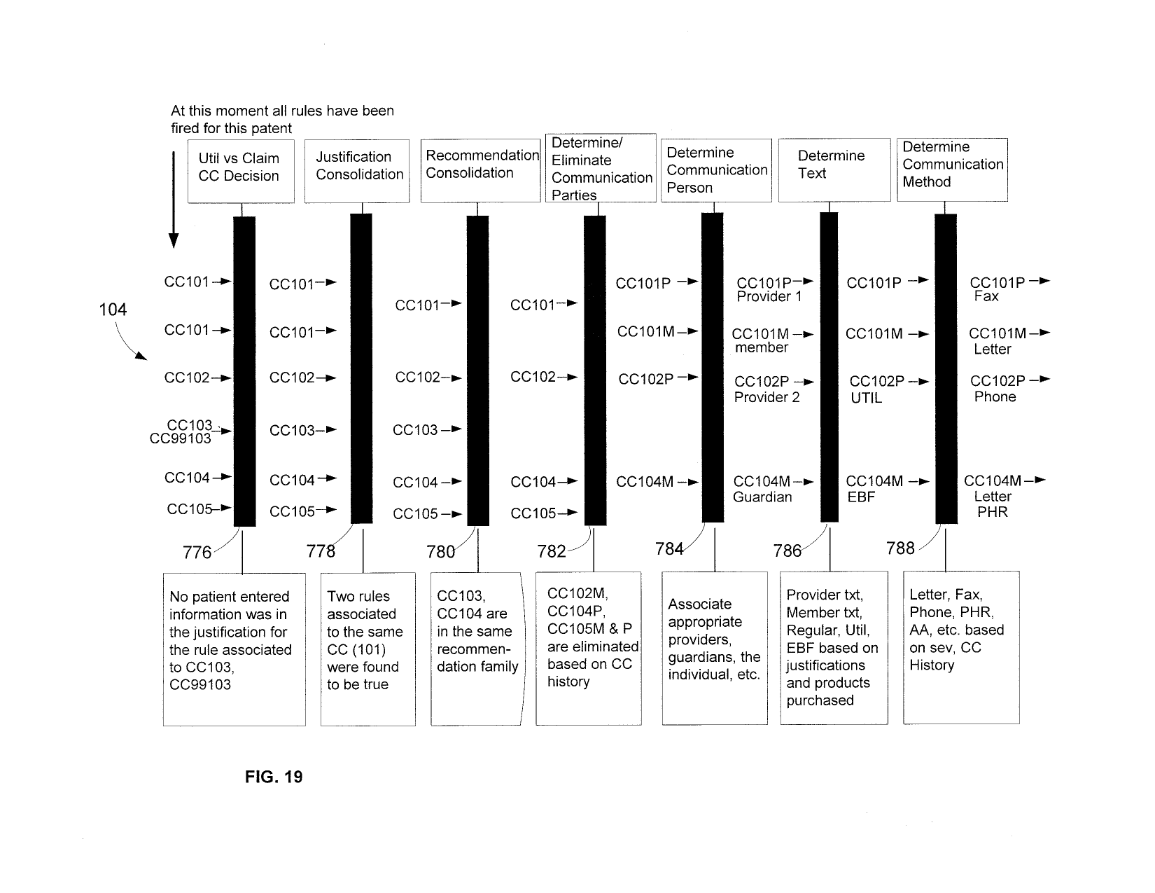

Turning to FIG. 19, an embodiment of a method of operation of the alert payload filtering module 768 is shown with respect to an alert workflow representing a plurality of clinical alerts 104 generated during a rule processing session 772 associated with a specific patient 102. Initially, all clinical rules 120 relevant to the patient 102 are evaluated by the rules engine module 126 in light of the incoming real-time data. The rules engine module 126 then generates a plurality of clinical alerts 104, each corresponding to a specific alert or recommendation and being identified by an alert number (e.g., “CC 101”-“CC 105”). In step 776, the alert payload filtering module 768 receives a plurality of clinical alerts 104 and eliminates multiple alerts which were generated by the same rule 120 but lack patient-entered information in its justification data. In this example, alert numbers “CC 103” and “CC99103” are generated by the same rule 120 with justification for “CC99103” lacking patient-entered information. Therefore, the alert payload filtering module 768 eliminates the alert corresponding to alert number “CC99103.” Next, in step 778, the alert payload filtering module 768 eliminates clinical alerts 104 that were generated when different rules 120 were found to be true, but resulted in the same alert or recommendation. In this case, incoming real-time data triggered two different rules 120, but generated identical alerts, each numbered “CC 101.” Hence, the alert payload filtering module 768 eliminates one redundant alert number “CC 101.” In step 780, the alert payload filtering module 768 consolidates outgoing alerts into recommendation families (e.g., alerts relating to potential drug interactions, medical test recommendations). In this case, alert numbers “CC 103” and “CC 104” are consolidated for delivery as a single alert number “CC 104.” In step 782, the alert payload filtering module 768 queries the medical database 118 to obtain history of alert delivery parties and alert delivery exclusionary settings with respect to specific alert types or numbers. For example, based on prior alert delivery history, alert number “CC 101” needs to be delivered to a health plan member or patient 102 and to the member's health care provider. Thus, alert “CC 101” is parsed into alerts “CC 101P” and “CC 101M” designated for delivery to the health care provider and to the member, respectively. On the other hand, alert number “CC 105” is eliminated based on exclusionary settings indicating that this particular alert number relates to a minor issue and may be suppressed (e.g., either to reduce the overall alert message payload, or based on provider and/or user settings). In one embodiment, for example, personalized wellness alerts 106 are given a lower priority than clinical alerts 106 and may be queued for future processing under high alert traffic conditions to ensure real-time delivery of critical alerts. Alternatively or in addition, clinical alerts 104 are assigned a severity level. For example, clinically urgent drug interaction alerts are assigned a higher severity level than recommendations for monitoring for side effects of drugs.

In step 784, the alert payload filtering module 768 further specifies the actual communication parties for each alert number. For example, alert number “CC 101P” is associated with a specific health care provider (e.g., “Provider 1”), while alert number “CC 102P” is associated with a different health care provider (e.g., “Provider 2”) based on matching health care provider specialties to the subject matter of each alert. Similarly, based on prior alert delivery history, the same alert may be delivered to both the patient and the health care provider (e.g., alert number “CC 101M” is designated for direct delivery to the member/patient 102, while alert number “CC 101P” is delivered to a health care provider). In step 786, the alert payload filtering module 768 customizes the alert text, including the alert justification information, to the designated delivery party and, optionally, to the specifics of the patient's health care plan. Finally, in step 788, the alert payload filtering module 768 designates an alert destination application or communication method for each filtered alert number for subsequent delivery by the message transmit web service 764. In embodiments, the alert destination applications and communication methods include a PHR application, an HRA application, an electronic medical record (EMR) application, a disease management application, a medical billing application, a fax application, a call center application, a letter, and combinations thereof.

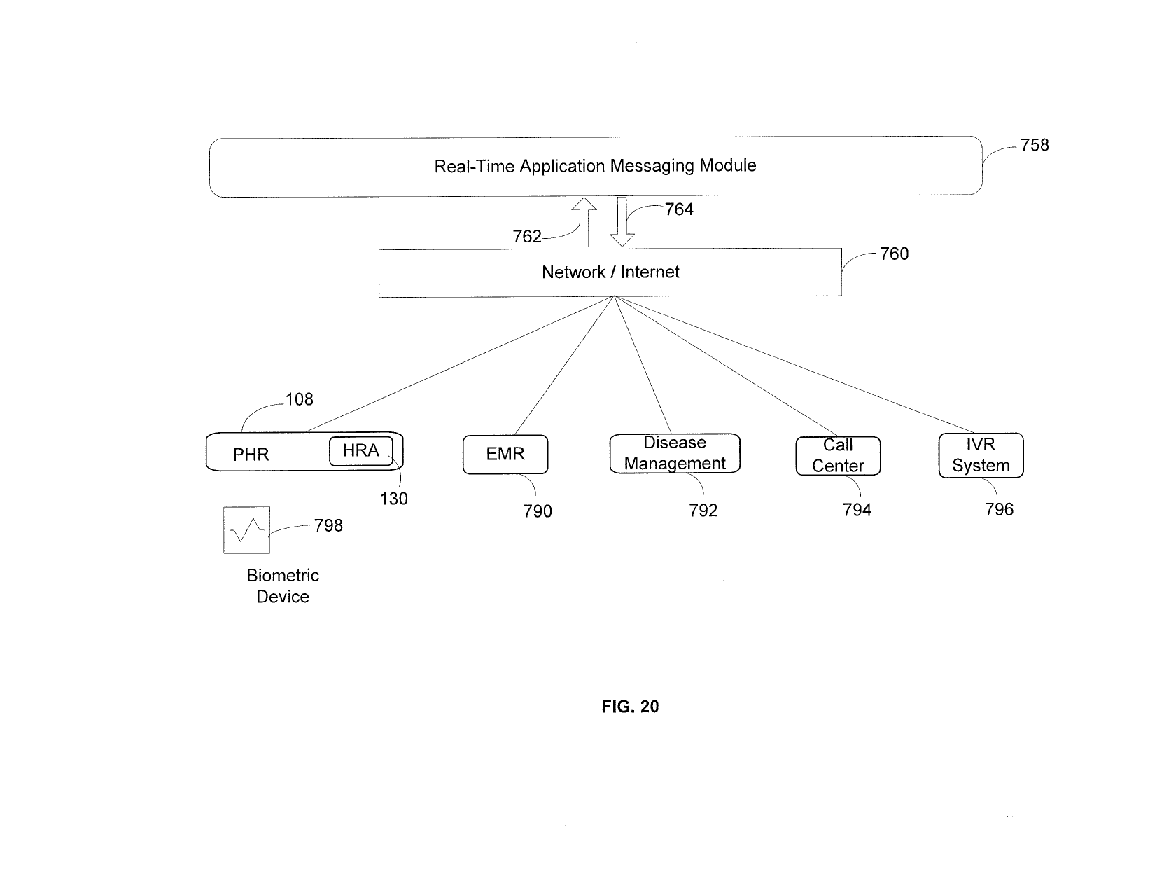

Turning to FIG. 20, exemplary real-time interactions of the health care organization 100 with a plurality of external systems and applications, via the real-time application messaging module 768, are illustrated. In one embodiment, once the patient 102 enters additional data 128 into the online PHR 108, such as a new over-the-counter medication, the message ingest web service 762 synchronously relays the new patient-entered data 128 to the real-time application messaging module 758 for defining a rules engine run 770 associated with the patient for real-time processing by the rules engine module 126. If the rules engine module 126 determines a variation between an actual mode of care, evidenced by the incoming and previously stored clinical data relating to the patient, and an evidence-based best standard of medical care, evidenced by the applicable clinical rules 120, it generates one or more clinical alerts 104. For example, a clinical alert 104 may alert the patient 102 that an over-the-counter medication selected by the patient may interact with one of the medications on the patient's drug regimen. Alternatively, a clinical alert 104 may alert the patient 102 that the over-the-counter medication (e.g., a cold medicine) is contraindicated due to the patient's condition, such as high blood pressure obtained from previously stored biometric device readings (e.g., blood pressure readings from a blood pressure monitor interfacing with the PHR 108, HRA 130). Likewise, the rules engine module 126 generates one or more clinical alerts 104 when the patient 102 completes a questionnaire via the online HRA 130 or via an integrated voice response (IVR) system 796. The message transmit web service 764 then synchronously delivers the clinical alerts 104 that pass though the alert payload filtering module 768 to the PHR 108, HRA 130, and/or IVR system 796.

Preferably, the incoming real-time patient data 128 and/or clinical data 114 triggers additional rule processing sessions 772 that cause the rules engine module 126 to generate real-time questions which prompt the patient 102 and/or the health care provider 110 to gather additional information. In addition to the incoming real-time data and the patient's existing health profile, the rules engine module 126 also takes into account the patient's risk score 105 for generating questions relevant to the patient's health. For example, for patients at risk for stroke due to hypertension, if the rules engine module 126 detects that the patient 102 should be taking an ACE inhibitor but is not, the rules engine module 126 generates a question regarding known allergies to ACE inhibitors. Similarly, if the rules engine module 126 detects that recommended diabetic monitoring tests are not present in the appropriate time frames within the stored clinical data 114 and/or patient-entered data 128, it generates a prompt for the test results. Likewise, when the patient is taking a drug that interacts with grapefruit juice, the rules engine module 126 generates a question about grapefruit juice consumption. In one embodiment, the rules engine module 126 presents additional dynamic questions based on answers to previous questions. For example, based on a risk score for coronary arterial disease (CAD) and underlying co-morbidities derived from previous answers, the rules engine module 126 generates questions relating to symptoms of angina.

The answers are transmitted back to the medical database 118 for storage and to the rules engine module 126 for further comparison with the best evidence-based medical standards of care 120. In embodiments, the rules engine module 126 performs real-time analysis of the patient's answers received via the HRA 130 or IVR system 796 and of the nurse or health care provider answers received via a disease management application 792 and/or an EMR 790.

To facilitate instant health care decisions, the health care organization 100 also receives real-time data from and delivers real-time alerts 104, 106 to one or more health care provider applications 756, such as an EMR application 790 or a disease management application 792. For example, during an office visit, a health care provider, such as a physician or nurse, enters prescription, diagnosis, lab results, or other clinical data 114 into an EMR application 790. In response to receiving this data in real-time, the rules engine module 126 instantiates a patient-specific rule processing session 772 (FIG. 18) and generates one or more clinical alerts 104 when the incoming data, as well as previously stored patient data, indicates a deviation from the best evidence-based best medical standards of care in light of the clinical rules 120. This allows the health care provider to make instant adjustments to patient's health care during the office visit, such as adjusting prescriptions and modifying test procedure referrals while the patient is waiting.

Similarly, clinical alerts 104 are presented to a clinician, such as a nurse associated with a medical insurance provider 112, via a disease management application 792. When a clinician interacts with the patient 102 over a telephone and uses the disease management application 792 to record the patient's answers to medical questions, the message ingest web service 762 relates the patient's responses entered by the clinician to the health care organization 100 for real-time processing. For example, if the patient's responses indicate that the patient is a smoker, the clinician is presented with patient-specific alerts 104 to relate to the patient during the telephone session (e.g., increased risk of blood clotting for smoking females taking oral contraceptives). In an embodiment, the clinical alerts 104 are delivered to a call center application 794 for contacting the patient or a physician for further follow-up. The call center application 794 synchronously schedules high severity clinical alerts 104 into a real-time call queue, while storing low severity alerts for subsequent call follow-up. Preferably, in conjunction with the clinical alerts 104, the rules engine module 126 also generates personalized wellness alerts 106 comprising evidence based medical standards of preventive healthcare and communicates this information to PHR 108, HRA 130, disease management application 792, EMR 790, and/or the call center application 794.

In another embodiment, the rules engine module 126 includes relevant educational materials, such as health reference information 122 and medical news 124, within the personalized wellness alerts 106 for patient's and/or health care provider's review in real-time. The rules engine module 126 identifies relevant health reference information 122 and medical news 124 based on a real-time analysis of the clinical data 114, patient-entered data 128, risk score 105, as well as incoming answers to dynamic questions. In embodiments, the health reference information 122 and medical news 124 are presented to the patient 102 upon logging into the PHR 108 or HRA 130, as well as to a nurse via the disease management application 792 during a live telephone call with a patient (based on entered patient data), and to a physician via an EMR 790 during an office visit. The educational materials may include, for example, health reference information 122 and medical news 124 relating to positive effects of diet and exercise when the patient 102 is a diabetic and the rules engine module 126 detects an elevated Hemoglobin A1C (HbA1C) test result. Similarly, based on a history of a heart attack and the patient's drug regimen compliance information (e.g., as entered by a health care provider), the rules engine module 126 presents relevant drug-related educational materials 122, 124 relating to the importance of taking medications for heart attacks. In yet another embodiment, the rules engine module 126 processes the patient's health data profile, the incoming real-time clinical data 114, as well as patient-entered data 128 and creates a custom contextual search query to continuously search for relevant medical literature (e.g., peer review journals, FDA updates, Medline Plus, etc) and actively push the search results to populate the research section 312 of the PHR 108 (FIG. 3). Alternatively or in addition, the rules engine module 126 pushes the search results in real-time to a plurality of health care provider applications 756, such as the EMR 790 and the disease management application 792 to empower the health care provider to educate the patient during a live telephone session or during an office visit.

Additional embodiments related to real-time processing of incoming data by the rules engine module 126 and real-time application messaging include patient population risk score analysis and physician performance measurement with on-demand rescoring. In one embodiment, the rules engine module 126 calculates the risk score 105 for a predetermined patient population within a health care provider's practice. When the health care provider 110 logs into an EMR application 790, he or she is presented with a list of all their patients organized by present condition along with appropriate risk score 105 associated with each patient population group. For example, high, moderate and low risk diabetics within a health care provider's patient population are organized in separate groups. This allows the health care provider to prioritize high risk patients, determine frequency of follow-up visits, use information to feed the advanced medical home and identify patients for future disease management sessions. When the health care provider 110 submits additional clinical data 114 to health care organization 100 via an EMR 790, the rules engine module 126 automatically recalculates respective risk scores 105 in real time for the health care provider's patient population and reloads the patient population display. Alternatively or in addition, the health care provider 110 requests risk score recalculation subsequent to entering additional clinical data 114. In one embodiment, the rules engine module 126 also recalculates the risk score 105 in real time for the health care provider's patient population upon receiving clinical data from patient-entered information 128 at the PHR 108 or the HRA 130. In this case, the message transmit web service 764 pushes updated patient population groups and associated risk scores 105 to the EMR 790. Based upon the risk score 105, the rules engine module 126 determines the appropriate time for a default medical office visit and whether the patient requires a referral to another health care provider (e.g., from a nurse to a practitioner or from a primary care physician to a specialist) to support the advanced medical home.

To provide real-time physician performance measurement, the rules engine module 126 evaluates previously stored and incoming clinical data 114, 128 in accordance with a predetermined set of clinical performance measures encoded in clinical rules 120 to provide ongoing feedback of self-performance to each physician and to help identify high performing physicians for the health care organization 100. For example, physicians that prescribe a beta blocker to all their patients with a Myocardial Infarction (MI) within a predetermined time frame are assigned higher performance scores among other physicians in an equivalent practice area. The clinical measurement for MI—Beta Blocker Use identifies the appropriate patients in the physician's practice that not only validate for a MI but also are appropriate candidates for using a beta blocker (i.e., no contraindications to beta blocker usage). This number makes up the denominator for this clinical measure; the next step is to identify the number of these patients who are currently taking a beta blocker. This will provide information to the physicians about which patients are currently not taking a beta blocker and allow review to see if non-compliance may be an issue. After appropriate follow-up with these patients, the clinical measure can be re-calculated to see if there is improvement in the measurement score. Recalculation of the score can also be used after documentation of reasons why patients in the denominator may not be appropriate candidates for beta blocker therapy which can then feed external review bodies like CMS Physician Voluntary Reporting Program. In an embodiment, a physician 110 accesses an online portal (either part of or separate from an EMR 790) to view his or her patient population and performance scores for each performance measure associated with a given patient or group of patients. The physician 110 also views the clinical data used to determine the performance score for each patient or group of patients. To initiate an on-demand rescoring of a performance score associated with a given patient or group of patients, the physician 110 enters additional information for a particular performance measure, such as that the patient is allergic or non-compliant with the prescribed drug regimen, or that the physician never treated the patient for a given condition. In response, the rules engine module 126 applies additional incoming data to the existing information relating to the patient and recalculates the physician's performance score with respect to the additional information, which refreshes the performance score display for the physician in real-time, in addition to storing the newly added information for future analysis by the rules engine module when generating clinical alerts. In one embodiment, health care organization 100 collates the clinical information that supports physician performance measurement results in a medical database 118 to support performance measurement reporting for each physician or group of physicians.

Referring again to FIG. 16, the rules engine module 126 provides the patient 102 and the health care provider 110 with real-time health trend ranges and corresponding clinical recommendations when the patient 102 and/or the health care provider 110 enters new health indicator data 744 into the PHR-based health tracking tool 740 or disease management application 792. Specifically, the rules engine module 126 processes the newly-received data point 744 in light of the previously stored health profile (e.g., prior health indicator readings, patient's chronic conditions, age, and sex) and the best evidence-based medical standards of care 120 to generate in real-time a normal or target range 748, as well as a high risk indicator 750, which provide context for the updated readings. For health indicators, such as blood pressure, which need to stay within a given target range 748, the high risk indicator 750 is demarcated via a high range and a low range. In addition to providing the target range and the health risk indicator, the rules engine provides specific messaging to the member to alert them if the health indicator like blood pressure is critically high to seek urgent medical care. In embodiments, the health indicator includes cholesterol levels, blood pressure readings, HbA1c test results, and body mass index (BMI) readings. In one embodiment, a clinician enters the health indicator results 744 via a disease management application 792 as reported by the patient 102 during a telephone session. In yet another embodiment, the health tracking tool 740 electronically interfaces with one or more biometric devices 798 (FIG. 20) in real-time to upload the health indicator data 744, such as by using a USB, serial, or wireless interface (e.g., Wi-Fi, ZigBee, Bluetooth, UWB) at the patient's computer. Exemplary biometric devices include a blood pressure monitor, a blood sugar monitor, a heart rate monitor, an EKG monitor, a body temperature monitor, or any other electronic device for monitoring and storing patient health indicator data. Alternatively or in addition, the health tracking tool 740 interfaces with an electronic storage device capable of storing medical data on a computer readable medium, such as USB, hard drive, or optical disk storage.

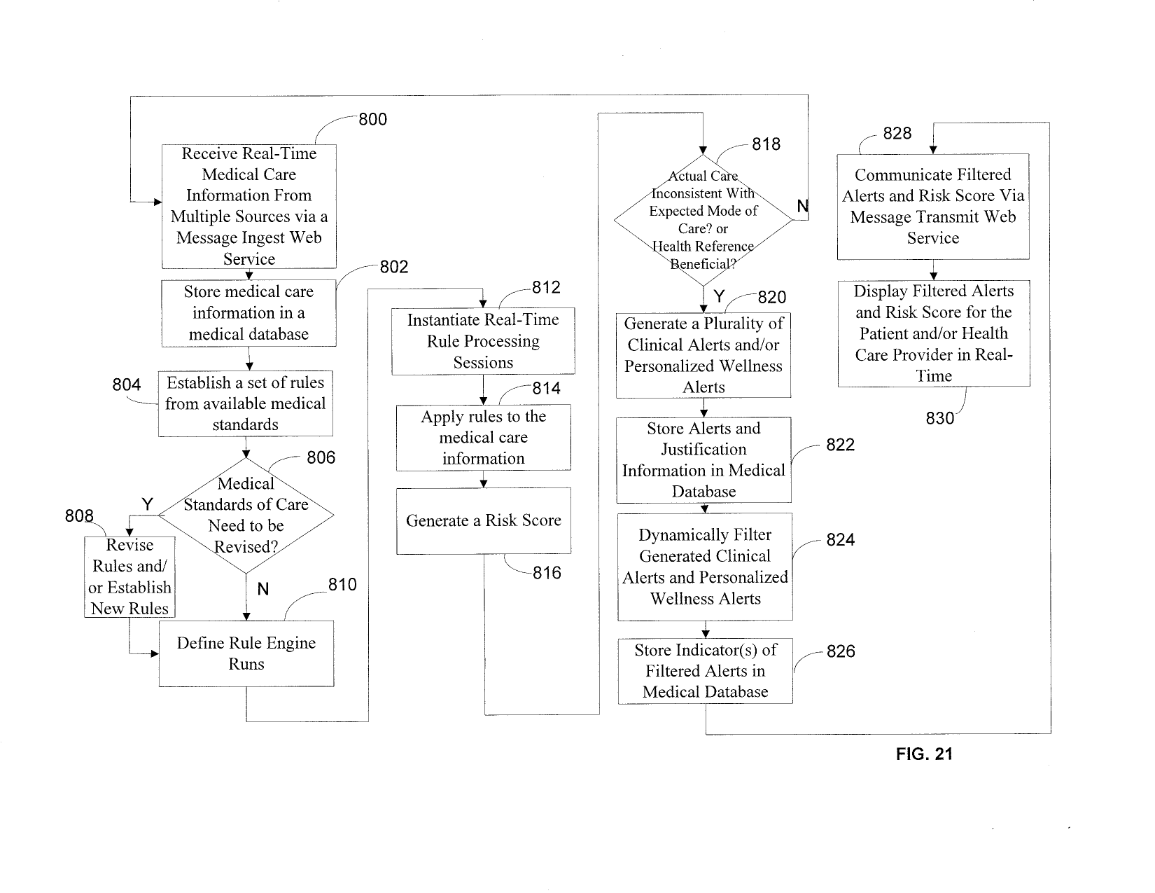

Turning to FIG. 21, an embodiment of a method of providing real-time processing and delivery of clinical alerts 104, risk score 105, and personalized wellness alerts 106 to the patient 102 and/or health care provider 110 is illustrated. In steps 800-802, the health care organization 100 receives real-time medical care information 114, 122, 124, 128 via a message ingest web service 762 and stores it in the medical database 118. In step 804, the health care organization 100 reviews collected health reference information 122 and establishes a set of clinical rules 120 based on best evidence-based medical standards of care for a plurality of medical conditions. When necessary, the health care organization 100 revises the medical standards of care embodied in the clinical rules 120 or establishes additional rules to reflect updates in the best evidence-based medical standards of care, steps 806-808. Otherwise, in step 810, the real-time application messaging module 758 defines a plurality of rules engine runs 770 for real-time processing by the rules engine module 126 in accordance with the rules 120 and based on incoming real-time data associated with each patient 102, as well as previously stored patient data at the database 118.

The rules engine module 126, in turn, instantiates real-time rule processing sessions 772 corresponding to each rule engine run 770 to apply one or more rules 120 to the incoming medical care information 114, 122, 124, 128 and patient's health profile stored at the medical database 118, steps 812-814. The rules engine module 126 generates a risk score 105 by using the clinical rules 120 to evaluate the risk of developing predetermined conditions in light of the patient data, step 816. When a given patient's actual care indicated by incoming and previously stored clinical data 114, 128 is inconsistent with an expected mode of care for a given condition, indicated by best evidence-based medical standards of care within the clinical rules 120, the rules engine module 126 generates a plurality of clinical alerts 104. Similarly, when incoming health reference information 122 is relevant and beneficial to the patient's clinical data, the rules engine module 126 also generates one or more personal wellness alerts 106 to notify the patient or the health care provider, steps 818-820. Upon generating the alerts 104, 106, the rules engine module 126 stores alert justification information for each alert at the medical database 118 and forwards all pending generated alerts to the alert payload filtering module 768, step 822.

To optimize the alert payload for real-time delivery, the alert payload filtering module 768 filters the alert input to the real-time application messaging module 758 by a plurality of conditions and categories (FIG. 19), stores indicators of filtered alerts 104, 106 in the medical database 118, and communicates filtered alerts, including the risk score, to the message transmit web service 764 for delivery, steps 824-828. Finally, in step 830, the message transmit web service 764 delivers filtered alerts 104, 106 and/or the risk score 105 for display to a patient via the PHR 108, HRA 130 and to a health care provider via health care provider applications 756, including an EMR 790, disease management application 792, and call center 794.

Some embodiments provide care management and care plan functionality. Care plans allow providers to define patient vision goals, problems, goals and actions for various patient conditions and track their status. Providers include nurses, care managers, medical assistants, doctors and others associated with healthcare related services. Providers may also be associated with insurance companies and other organizations with an interest in patient health. Using the care engine, care plans are generated to address the vision goals, problems, goals and actions for a patient. Care plans can be generated and updated in real-time using the methods and systems described above. In some embodiments, a provider identifies patients that may particularly benefit from care management.

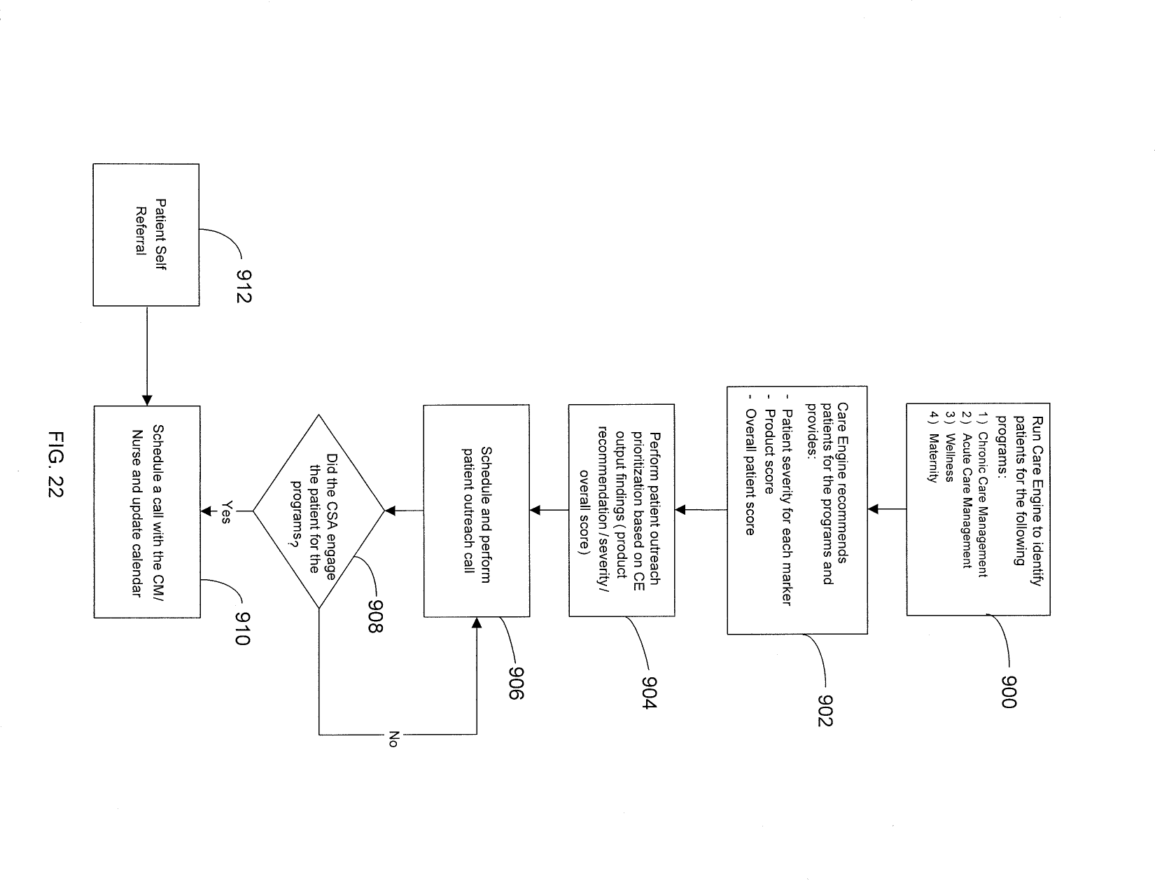

Turning to FIG. 22, an embodiment of a method for identifying and prioritizing patients that may benefit from care management is illustrated. In step 900, the CareEngine® system 125 is run to identify patients that may benefit from care management. Exemplary care management programs include chronic care management, acute care management, wellness and maternity. At step 902, the engine recommends specific patients that may benefit from care management. The patients recommended at step 902 may be a subset of the patients identified at step 900 or may include all patients identified at step 900. Exemplary criteria used to recommend patients include patient severity for each marker, product score and overall patient score. A marker represents a particular condition associated with a patient. The product score quantifies the opportunity for outreach given a particular care management program.

After recommending patients for outreach, at step 904 patient outreach is prioritized based on the scores developed at step 902. At step 906, patient outreach is conducted. Exemplary forms of outreach include a telephone call, in-person meeting, an email or another form of electronic messaging. At step 908, it is determined whether a patient was successfully contacted. At step 910, an appointment is scheduled with a case manager. Additionally, at step 912, patients may self refer themselves for care management and initiate an appointment with a care manager at step 910.

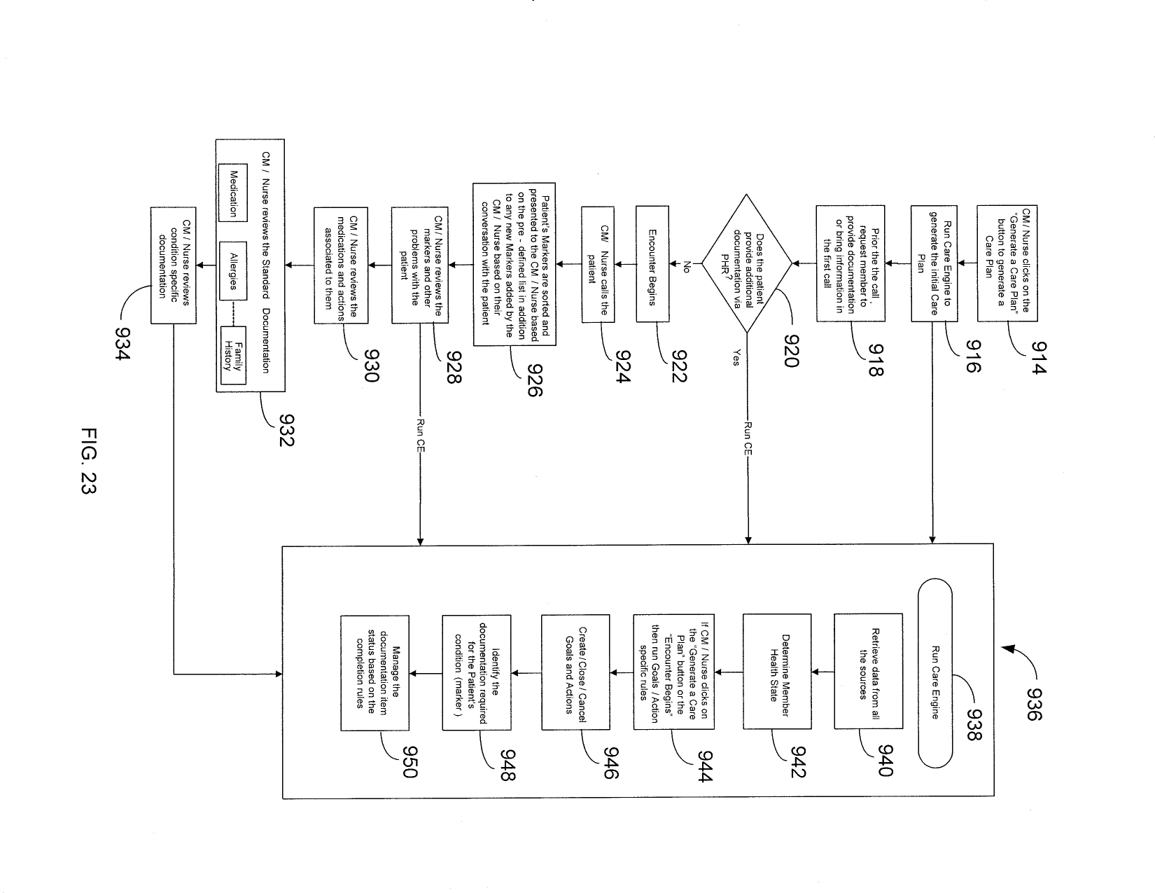

Turning to FIG. 23, one embodiment of a method for identifying specific conditions associated with a patient that may benefit from care management and engaging the patient is illustrated. At step 914, the care manager initiates the generation of a care plan for a patient and at step 916, the care engine is initiated. In this embodiment, the care engine 936 includes additional modules associated with care management. The care engine run begins at step 938. At step 940, data is retrieved from all available sources as described above including, for example, real-time medical care information clinical data 114, health reference information 122, medical news information 124, and patient-entered data 128. Additionally, a care manager can provide information to the care engine. At step 942, the member health state is determined. This step determines what managed care plans may be active for an individual patient. The care engine generates the member health state by determining any markers, conditions, at risk conditions, and the clinical risk stratification for particular markers as described above with respect to the risk score. Monitored events can be clinical or non-clinical. The risk score quantifies the severity of existing medical conditions and assesses the risk for future conditions in light of evaluating multiple risk factors in accordance with the clinical rules.

In one embodiment, the care engine includes a set of clinical rules to analyze the current state of the patient's health profile and monitored events. The patient's health profile consists of conditions, co-morbidities and at risk conditions. Each condition is further stratified to determine the level of the clinical risk as high, moderate or low based on whether the condition is under control and the development of complications. In addition to the health profile, care engine analyzes a set of monitored events across all patients as well as monitored events that are tailored to the patient's health profile. Monitored events may include: a) adherence to evidenced-based recommendations e.g., the use of statins in patients with CAD; b) gaps in care including those related to starting treatment, modifying drug therapy, monitoring for complications and/or diagnostic workup; c) lifestyle behaviors such as sleep habits; d) preventive care e.g., screening for skin cancer in kidney transplant recipients); e) condition specific targets/goals e.g., achieving a health weight (BMI <25); f) program identification and participation e.g., enrolling in a disease management program; g) completion of specific tasks e.g., having an advance directive; h) readiness to change and health goals e.g., planning to quit smoking; i) development of an adverse event or significant change in lab results e.g., hospitalization for heart failure; j) compliance with medications e.g., medications prescribed that are not filled; k) duplication of medications or ordered tests; l) eligibility for specific benefit designs e.g., medication co-pay reduction; m) appointment priority and missed appointments; n) provider referral recommendations; o) consumer preferences e.g., methods of communications, program engagement.

The state of the patient is constantly changing with the occurrence of new information and/or with the lapse of time. A patient's condition may progress in severity or may resolve with treatment. In one embodiment, the care engine will identify the current state of the member and will maintain the history of the member which the care engine can refer to in clinical rules. The care engine analyzes all available clinical data (e.g., claims, drug data, lab results, EMR data, hospital data, and patient collected data) to present clinically pertinent and intelligent information to the healthcare team and patient at the point of care. The care engine in real time can utilize all available clinical data to identify the current list of conditions, comorbidities and at risk conditions at a population and patient specific level.

At step 944, goals and actions rules are run as necessary. For example, a case manager may request a care plan be generated or a care plan may be generated when an encounter with a patient begins. Goals include high-level items such as “quit smoking.” Actions include tasks that enable a patient to achieve a particular goal. At step 946, goals and actions are created, closed and/or cancelled. The goals and actions can be created based on the real-time medical care information, clinical data 114, health reference information 122, medical news information 124, and patient-entered data 128. In this way, actions are intelligently created by taking into account all of the medical information available to the engine. Actions that have already been completed will not be added to the care plan. Next, documentation related to a patient's marker(s) is identified at step 948. At step 950 the documentation is managed based on, for example, the completion rules.

At step 918 any additional information needed from the patient is requested. Step 918 may occur at anytime prior to the first call with the patient or may occur when additional information becomes necessary. At step 920, any information provided by the patient is input to the care engine. The care engine can then update the care management plan as necessary based upon the newly entered information. The update can occur in real-time or be batch processed at a later time. At step 922, contact with the patient is initiated and at step 924 the care manager contacts the patient. At step 926, the system presents the care manager with the patient's markers sorted based on a pre-defined list. In this embodiment, the care engine generates the list. The care manager can add markers to the list based on the conversation with the patient. At step 928, the care manager reviews the markers and other issues and problems with the patient. Then, at step 930, the case manager reviews the medications and actions with the patient. The case manager, at step 932, reviews the documentation associated with the care plan. Documentation may include information on medications, allergies, family medical history and other documents that may be relevant to a care plan. At step 934 the care manager reviews any care specific documentation. The care manager can update information in the care engine based on information received from the documentation. The care engine analyzes new information in real-time and the analysis may impact the care plan and personal assessment for the patient.

In some embodiments, the care engine 936 runs in real-time as described above. The care manager updates the care plan in real time based on information input by the case manager. The case manager can view the updated care plan during the encounter with the patient.

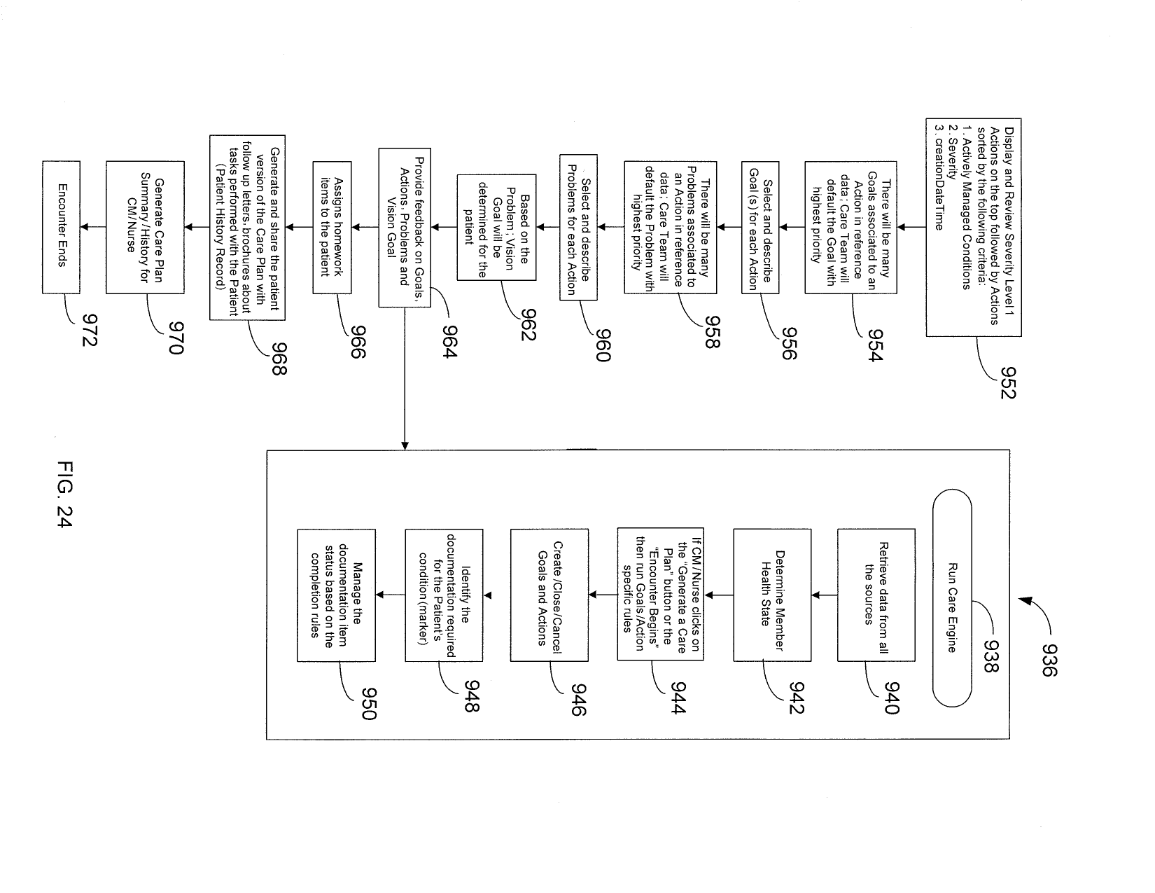

After generating the care plan and initiating contact, the care manager engages the patient to administer the care plan as illustrated in FIG. 24. Initially, the care manager reviews high severity, level 1, actions at step 952. Actions can be sorted in any manner. For example, actions may be sorted by severity, actively managed conditions, or creation date and time. Next, at step 954, the case manager reviews goals associated to an action. Some actions may be associated with multiple goals. Goals can be sorted in any manner, such as by severity, actively managed conditions, or creation date and time. After reviewing the goals associated to an action, the case manager selects and describes the goals for each action to the patient at step 956. At step 958 the care manager reviews problems associated with each goal and action. Problems can be sorted in a number of ways including by severity, actively managed conditions, or creation date and time.

At step 960, the care manager discusses problems associated with each action with the patient. Based on the problems a patient has, the patient and care manager create a vision goal for the patient at step 962. A vision goal is a high level patient goal. For example, a patient might have a goal to live long enough to see her granddaughter graduate from high school. At step 964 the care manager and patient discuss the vision goal, problems, goals and actions. Each of these categories should relate to one another. If any changes are made, the care engine can update the care plan in real-time.

The care manager can assign homework to the patient at step 968. Homework can include items such as reading informational material, watching a video or exercising. At step 970, a care plan summary is generated and historical information is displayed for the case manager. Based on the summary and historical information, the case manager discusses any additional issues with the patent and at step 972 the patient encounter ends.

The care management system allows dynamic and personalized clinical assessments across all conditions and issues powered by the CareEngine. The CareEngine rules may run in real-time to help make each assessment individualized and concise, helping to improve operational efficiency without sacrificing member experience. As described above, the assessment is a component of the care plan. The assessment identifies, for example, areas where additional information is needed. The assessment is generated based on the care engine analysis of the member health state. In traditional disease management conversations are scripted to help ensure consistency. This often leads a focus on data collection, and forces the conversation to occur in a certain order even with branching logic.

For example, a nurse addressing a member with COPD (chronic obstructive pulmonary disease) and trying to educate the member on steroids and the potential risk of osteoporosis (weak bones) from long term use might ask the following questions to each member: (1) In the past 6 months, have you been on oral steroids (pill or liquid that is swallowed, not inhaled)? (2) (Sub-question if answer on steroids for at least 3 months) Calcium and vitamin D are important for healthy bones. Are you getting enough calcium and vitamin D from dietary sources? (3) (Sub-question if answer on steroids for at least 6 months) Have you ever had a bone test to evaluate you for osteoporosis? In the CareEngine powered assessment, the CareEngine looks at all available information from claims, HIE, patient self-report in real-time to help tailor these questions to each individual member. For example, if patient 1 was a 75 year female with COPD and osteoporosis on treatment for osteoporosis when the nurse did her assessment the nurse would not see any of these questions, but only education for the member on current osteoporosis treatment if needed. For patient 2, a 78 year old female with COPD on steroids for 1 year, with a bone test in the last year would not get any of these questions. For patient 3, a 61 year old male not on steroids (known because already answered in HRA) would not get any of these questions, until after 1 year to make sure everything was still current. For patient 4, a 54 year old male where it is unknown if he is on steroids, he would be asked question 1 and then potentially questions 2 or 3 based on branching logic if appropriate.

In this way a nurse who may have originally asked 15 questions to every member with COPD, will now only ask those that are relevant to the member and not already known.

All references, including publications, patent applications and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of generating a customized patient care plan for an individual patient, the method comprising:
electronically querying a set of clinical rules from available evidence-based medical standards stored on a non-transitory computer readable medium;
interfacing with at least one network service for receiving medical care information relating to a plurality of patients, the at least one network service having real-time access to at least one source of data, including claims data containing clinical information relating to the plurality of patients;
identifying at least one patient for care management from the plurality of patients based on the claims data containing clinical information relating to the patient;
compiling a list of markers associated with the patient based on the claims data containing clinical information relating to the patient;
generating a care plan for the patient using the claims data containing clinical information relating to the patient, wherein the care plan includes at least one action relating to the markers associated with the patient.

2. The method of claim 1 further comprising transmitting the care plan for display to the care manager.

3. The method of claim 1 further comprising gathering information relating to the markers from the patient.

4. The method of claim 1 further comprising identifying at least one problem associated with each marker.

5. The method of claim 1 further comprising generating a personalized clinical assessment for the patient.

6. The method of claim 1 further comprising generating homework assignments relating to the marker for the patient.

7. The method of claim 1 further comprising generating documentation relating to the marker for the patient.

8. The method of claim 1 further comprising generating a care plan summary for display to the care manager.

9. The method of claim 1 wherein generating the care plan occurs in real time as data becomes available to the claims engine.

10. A system for generating a care plan for an individual patient, the system comprising:
a database configured to maintain medical care information relating to the patient through a real-time application messaging module comprising at least one network service, the at least one network service having real-time access to at least one source of data, including claims data reflecting clinical information relating to the patient obtained from at least one health care provider and submitted in connection with a claim under a health plan;
an interface configured to connect to a network service for receiving medical care information relating to the patient, the network service having real-time access to at least one source of data, including claims data containing clinical information relating to the plurality of patients;
a rules engine configured to apply a set of clinical rules to the contents of the database in real-time to identify at least one marker associated with the patient and to generate a care plan for the patient based upon the identified marker.

11. The system of claim 10 further comprising an interface configured to connect to an electronic care manager interface configured to display the care plan.

12. The system of claim 10 wherein the rules engine is further configured to generate the care plan in real time.

13. The system of claim 10 wherein the rules engine is further configured to identify at least one problem associated with the marker.

14. The system of claim 10 further comprising an interface configured to receive information relating to the marker from a computer associated with a care manager.

15. A non-transitory computer readable medium having stored thereon computer executable instructions for generating a customized patient care plan for an individual patient, the instructions comprising:
electronically querying a set of clinical rules from available evidence-based medical standards;
interfacing with at least one network service for receiving medical care information relating to plurality of patients, the at least one network service having real-time access to at least one source of data, including claims data containing clinical information relating to the plurality of patients;
identifying at least one patient for care management from the plurality of patients based on the claims data containing clinical information relating to the patient;
compiling a list of markers associated with the patient based on the claims data containing clinical information relating to the patient;
generating a care plan for the patient using the claims data containing clinical information relating to the patient, wherein the care plan includes at least one action relating to the markers associated with the patient.

16. The computer readable medium of claim 15 further comprising instructions for transmitting the care plan for display to the care manager.

17. The computer readable medium of claim 15 further comprising instructions for gathering information relating to the markers from the patient.

18. The computer readable medium of claim 15 further comprising instructions for identifying at least one problem associated with each marker.

19. The computer readable medium of claim 15 further comprising instructions for generating documentation relating to the marker for the patient.

20. The computer readable medium of claim 15 further comprising instructions for generating a care plan summary for display to the care manager.
